(19) United States
(12) Patent Application Publication
(10) Pub. No.: US 2002/0131127 A1
(43) Pub. Date: Sep. 19, 2002

(54) Coherent wavelength-shift multiplexing apparatus

(76) Inventor: Michael H. Myers, Poway, CA (US)

Correspondence Address: Gary L. Eastman, Esq., All Optical Networks, Inc., 9707 Waples Street, San Diego, CA, 92121, US

(21) Appl. No.: 09/921,761

(22) Filed: Aug. 3, 2001

Related U.S. Application Data
(63) Continuation-in-part of application No. 09/810,910, filed on Mar. 16, 2001.

(51) Int. Cl. H04J 14/02; H04B 10/00

(52) U.S. Cl. 359/161; 359/124

(57) ABSTRACT

An apparatus for coherent wavelength-shift multiplexing splits a photonic signal of limited coherence length into a plurality of daughter signals. Each daughter signal is modulated with a modulation waveform configured to shift the wavelength of the photonic input signal and provide a photonic output signal with a unique wavelength pattern corresponding to a channel. Each photonic output signal corresponding to a data channel is also encoded with a data signal by pre-modulating the modulation waveform. Wavelength errors are detected to provide a wavelength error signal. The wavelength error signal is used to adjust the modulation waveforms to stabilize the wavelength of the photonic output signals and correct channel wavelength errors. Fixed wavelength channels and spread spectrum channels are supported by the present invention. The photonic output signals are combined onto a single medium to provide a multiplexed photonic signal.

### 1. RELATED APPLICATIONS

This application is a continuation in part of U.S. patent application Ser. No. 09/810,910 filed Mar. 16, 2001 and entitled PHOTONIC WAVELENGTH SHIFTING APPARATUS, and incorporated herein by reference.

### BACKGROUND OF THE INVENTION

2. Field of the Invention

This invention relates to computer systems, telecommunication networks, and switches therefor and, more particularly, to novel systems and methods for transmitting, switching and multiplexing photonic information.

3. Description of the Related Art

The issue of sending and receiving information or message traffic is of major consequence in virtually all aspects of industrial and commercial equipment and devices in the information age. Whether communications involve sending and receiving information between machines, or telecommunications of data signals, audio signals, voice, or the like over conventional telecommunications networks, the sending, routing and delivery of information is paramount.

Signals are predetermined codes, patterns or the like used to communicate information. Signals allow a sender and receiver to communicate efficiently and effectively. Photonic signals are signals communicated with electromagnetic radiation such as light. Photonic signaling occurs by changing the characteristics of electromagnetic radiation such as light in a manner recognized by both sender and receiver.

Modulation is often used as a signaling or encoding mechanism for photonic signals. Modulation is the act of varying an attribute or characteristic of a signal such as wavelength, intensity, phase or the like. Modulation facilitates the transfer of information between a sender and a receiver.

Photonic signals are often characterized in terms of wavelength. The wavelength of a photonic signal indicates the length of one cycle of electromagnetic radiation and is related to its rate of vibration as it propagates through a medium. To send information efficiently, a photonic signal is often a composite signal composed of multiple wavelengths that are transmitted simultaneously.

A spectrum is a range of wavelengths (or frequencies) of electromagnetic radiation such as light. Signaling may involve modulating or changing the spectral characteristics of electromagnetic radiation. The spectral characteristics of a signal i.e. the wavelengths that it is composed of may determine its interaction with physical matter such as optical fibers, reflectors, prisms or the like. For example, light propagating through a prism may bend at different angles depending on its color or wavelength.

Channels are a mechanism to facilitate communications between multiple senders and receivers. Each sender and receiver connects to a channel when sending and receiving information. Channels allow a single transmission medium such as fiberoptic cable to carry multiple streams of information simultaneously. Each channel may signal using a different wavelength known as the carrier. The carrier is essentially the bearer of the information stream.

Multiplexing is the act of combining multiple signals or channels onto a common physical medium. Wavelength-division multiplexing implies combining multiple signals onto a medium where each signal has a different wavelength. Time-division multiplexing implies multiple channels communicating over a shared medium at different times or timeslots. Switching is a mechanism to change the channel to which particular senders and receivers are connected. Switching may also be used to change the physical medium upon which a channel is transmitted. To be most useful, communications and switching equipment must interface with channels from a plethora of sources. An ability to transmit and redirect multiple channels simultaneously and independently, increases the capacity and usefulness of transmission, multiplexing and switching equipment.

With the advent of photonic signals and photonic signal processing, new speed limits are being approached by transmission media. Moreover, origination of signals may now be executed literally at light speeds. Accordingly, what is needed is a system for connecting senders and receivers over a photonic medium in such a way as to maximize speed, while maintaining the integrity of information.

Over the years several standard methods have been developed for packing multiple channels onto a single transmission medium. In optical frequency division multiplexing (OFDM) and wavelength division multiplexing (WDM), each channel has a unique wavelength that typically remains constant with time. In spread-spectrum systems, all channels may have substantially the same average wavelength with short term variations that are unique to each channel. Sets of orthogonal functions may be used to define channel wavelengths. Orthogonal functions are patterns that do not interfere or correlate with each other

In most systems and applications, it may be desirable that the wavelength of each channel be described as a function of time, distinct and unique from all other channels (i.e. that each channel have a unique wavelength pattern). An ability to wavelength shift photonic signals from one channel of a given wavelength pattern into a wavelength pattern associated with an arbitrary channel would facilitate the transmission, multiplexing, and switching of a wide range of photonic signals.

Wavelength variability is a measure of deviation from a desired wavelength or wavelength pattern. Wavelength variability often reduces the number of channels that may be switched or multiplexed. An ability to reduce wavelength variability would increase the channel density of transmission, multiplexing and switching equipment.

One dilemma in engineering photonic systems is the conversion of signals or information between the electronic and photonic domains. Photonic systems are capable of high transmission rates and distances. Computers and control equipment are typically electronic due to their flexibility, low cost, and wide availability.

Typically, switching and multiplexing require the conversion of optical signals into electrical signals for processing and control, followed by reconversion into the optical domain for further transmission. An ability to direct and control a photonic stream of data with electronic devices and systems without requiring conversion of the photonic data stream to the electronic domain would leverage the best characteristics of each domain.

While it may be desirable to leave data in the photonic domain when transmitting, multiplexing and switching photonic signals, it is often desirable to encode an electronic data signal onto an existing carrier without additional complexity and cost. An ability to process both photonic and electronic signals with the same mechanism would simplify interfacing with a wide range of communications, process control, and computational equipment.

One difficulty in interfacing a wide variety of photonic equipment is the assignment of channel wavelengths and encoding techniques. Setup and configuration become problematic. An ability to automatically channelize (i.e. change the wavelength of a photonic carrier to a given channel) and transparently pass along a photonic signal across a network of photonic equipment without prior knowledge of the channel wavelengths and encoding techniques would reduce the cost and complexity of deploying photonic equipment.

Another issue in photonic transmission systems is wavelength variations due to component variability, temperature drift, system jitter, and other factors. Wavelength variability makes it difficult to densely pack channels onto a transmission medium without collisions occurring, especially when multiplexing channels from multiple sources. Typically, expensive, temperature-compensated, reference lasers or light sources are required to stabilize a photonic signal.

Most state-of-the-art photonic transmission systems require conversion to the electronic domain followed by remodulation of a light source and retransmission in order to eliminate any jitter introduced during transmission. An ability to compensate for wavelength variability of existing photonic streams without remodulation and retransmission would increase the capacity and lower the cost of transmission, multiplexing and switching equipment.

### BRIEF SUMMARY AND OBJECTS OF THE INVENTION

In view of the foregoing, it is a primary object of the present invention to provide a method and apparatus for transmitting, multiplexing and switching photonic signals without requiring conversion to the electronic domain. Preferably such a method and apparatus may include the ability to embed electronic data signals onto existing photonic carriers and signals.

One object of the invention is to provide a system that facilitates the transmission, multiplexing and switching of a wide range of photonic signal types. It is also an object of the invention to provide a system for multiplexing photonic signals over photonic carrier media in such a way as to maximize speed, while maintaining the integrity of information.

Another object of the invention is to provide the ability to interface with photonic signals from a plethora of sources and to provide apparatus and methods for transmitting and redirecting those signals simultaneously and independently. It is a further object of the present invention to provide the ability to wavelength shift photonic signals from one channel of a particular wavelength or wavelength pattern into any other channel without requiring conversion to and reconversion from the electronic domain.

It is also an object of the invention to provide the ability to automatically channelize and transparently pass along a data encoded photonic stream across a network of photonic equipment without prior knowledge of the channel wavelengths or encoding methods. Another object of the invention is to provide the ability to compensate for wavelength variability of existing photonic streams without retransmission. It is an object of the present invention to reduce the wavelength variability of a photonic signal and thereby increase the number of channels that may be transmitted, multiplexing and switched on a photonic medium.

Consistent with the foregoing objects, and in accordance with the invention as embodied and broadly described herein, an apparatus and method are disclosed, in suitable detail to enable one of ordinary skill in the art to make and use the invention. The present invention uses various embodiments to wavelength shift photonic signals. Wavelength shifting changes the wavelength or wavelengths of a photonic signal without requiring retransmission. Wavelength shifting may also be applied as a mechanism to multiplex, switch, and transmit photonic signals.

The present invention associates the desired wavelength of a channel with a wavelength pattern. The act of wavelength shifting a photonic signal to match the wavelength pattern of a channel is referred to herein as channelization. Wavelength patterns may be constant as in systems with a fixed channel spacing. However, wavelength patterns are often dynamic and may overlap in frequency or wavelength.

In certain embodiments in accordance with the invention, an apparatus for wavelength shifting uses modulation techniques to change photonic signal wavelengths. Modulation techniques may be selected to be appropriate to a modulation device of choice. A modulation device may be driven or controlled by a modulation synthesizer that produces a controlling waveform referred to as the modulation waveform. The modulation synthesizer may vary the modulation waveform in response to various controls or signals and thereby effect certain results such as, but not limited to, encoding data, performing wavelength stabilization or changing the channel of a photonic signal.

In certain embodiments an apparatus and method for wavelength shifting in accordance with the present invention may include a modulation synthesizer, a modulation device and a wavelength error detector. The modulation synthesizer may generate a modulation waveform that controls or drives a modulation device that in turn acts upon a photonic signal. Various effects may be embedded in the modulation waveform including but not limited to wavelength shifting, wavelength stabilization and data encoding. The wavelength error detector may provide an error signal to facilitate wavelength stabilization.

Various modulation devices may be used in accordance with the invention, including but no limited to, phase modulation devices and quadrature mach-zehnder modulation devices. The modulation synthesizer may be designed and optimized to control a particular modulation device. In some embodiments in accordance with the invention, the modulation waveform may be a quadrature waveform comprised of multiple waveform components that are orthogonal to (i.e. do not correlate or interfere with) one another.

The wavelength shifter and modulation synthesizer in accordance with the invention may also include input signals for dynamically controlling wavelength shifting and data encoding. In certain embodiments, a shift signal may contain wavelength patterns effective to change the channel of a photonic carrier. In some embodiments a data signal may be provided for encoding data onto a photonic carrier.

In certain embodiments an apparatus and method for wavelength error detection in accordance with the present invention may filter and compare two photonic signals to provide an error signal. The error signal may be used as feedback mechanism for wavelength shifting. In some embodiments, the two photonic signals that are filtered and compared may be the same photonic signal with slightly offset wavelength shifts.

An apparatus and method for channelizing unknown photonic signals in accordance with the invention may include a wavelength detector, a channel allocator and a wavelength shifter. The unknown photonic signals such as those generated by legacy equipment may be automatically characterized and directed to an available channel or set of channels. The wavelength detector may provide a wavelength signature that captures the information essential to properly channelize unknown photonic signals. The wavelength shifter may channelize the unknown photonic signals by altering the wavelength pattern of a carrier or group of carriers.

An apparatus and method for tunable wavelength-stabilized transmission in accordance with the invention may include a coherent light source and a wavelength shifter. The coherent light source may have wavelength variability that is unacceptable for a particular application. The wavelength shifter may stabilize and encode data onto the coherent light source.

An apparatus and method for recursive wavelength shifting in accordance with the invention may include amplifying, splitting, wavelength shifting, and combining a photonic signal within a recursive loop. Each pass through the recursive loop may spectrally replicate a photonic signal. The spacing of the replicated signals may be controlled by providing a shift signal. The wavelength bounds of the replicated signals may be controlled by filtering. Spectral combs and the like may be generated by recursive wavelength shifting.

An apparatus and method for coherent wavelength shift multiplexing in accordance with the invention may include a modulation synthesizer, a wavelength error detector, and multiple modulation devices. A splitter may split a coherent light source into multiple daughter signals. Each modulation device may modulate a daughter signal to provide a photonic signal with a unique channel.

The modulation synthesizer may generate a set of modulation waveforms encoded with a unique wavelength (shifting) pattern for each modulation device. Each wavelength pattern may be associated with a unique channel. The modulated photonic signals (including a reference signal) may be combined to provide a multiplexed photonic signal.

An apparatus and method for wavelength-shift transceiving in accordance with the invention may include a narrowband filter and a wavelength shifter. The narrowband filter may isolate a narrowband signal from a broadband photonic signal. The wavelength shifter may convert the narrowband signal to and from a channel or group of channels within a multiplexed photonic signal. Wavelength-shift transceiving may be used as a full-duplex or half-duplex building block for switching, multiplexing and transmitting photonic signals.

An apparatus and method for narrowband filtering in accordance with the invention may use circulators and reflecting filters to isolate narrowband signals from broadband photonic signals. Various embodiments may be half-duplex, full-duplex, or pseudo-full-duplex. In some embodiments, multiple narrowband filters may share a single reflecting filter.

A full-duplex crossbar switch in accordance with the invention may use a wavelength-shifting transceiver as a building block. A number of wavelength-shifting transceivers may extract narrowband signals from broadband signals. Each extracted narrowband signal may be channelized by one of the wavelength shifting transceivers to produce a number of channelized photonic signals. The channelized photonic signals may be combined to create a multiplexed photonic signal. In some embodiments the wavelength-shifting transceiver may be full-duplex facilitating the simultaneous demultiplexing of channels (or groups of channels) within the multiplexed photonic signal to narrowband signals.

A full-duplex wavelength-shifting switch element in accordance with the invention may include a narrowband filter and two wavelength shifters. Each wavelength shifter may convert the carrier of a selected channel (or group of channels) within a multiplexed photonic signal to and from the passband of the narrowband filter. The narrowband filter, which may be full-duplex, may essentially exchange the selected channels between the wavelength shifters. Each wavelength shifter, which may also be full-duplex, may convert the exchanged channel (or group of channels) to a destination channel (or group of channels). The exchanging of the selected channel and the destination channel may constitute switching.

A full-duplex wavelength-shifting switch in accordance with the invention may include a number of full-duplex wavelength-shifting switch elements in a parallel configuration. Each full-duplex wavelength-shifting switch element may exchange channels from one multiplexed photonic signal with channels on another multiplexed photonic signal. The number of full-duplex wavelength-shifting switch elements that are placed in parallel may be arbitrary facilitating the creation of full-duplex switches of arbitrarily capacity. In some embodiments, the full-duplex wavelength-shifting switch elements may share the same narrowband filter.

A replicated-spectrum transceiver in accordance with the invention may include a spectrum replicater and a narrowband filter. The spectrum replicater may spectrally replicate copies of a photonic signal at various wavelengths. The replicated copies preferably cover a very broad spectrum with little unused bandwidth between the replicated copies. The narrowband filter may pass at least one replicated copy to a multiplexed photonic signal. In certain embodiments the narrowband filter may be tunable to an arbitrary passband wavelength.

An apparatus and method for spectrally replicating a photonic signal in accordance with the invention may include a modulation synthesizer and a modulation device. The modulation synthesizer may generate a harmonic rich modulation waveform. The modulation device may modulate the photonic signal and produce one or two copies of the photonic signal for each harmonic of the harmonic rich modulation waveform.

An apparatus and method for recursive wavelength-shift replication in accordance with the invention may spectrally replicate a photonic signal by recursive wavelength shifting. Each pass through the recursive wavelength shifting loop may spectrally shift and replicate a photonic signal. The spacing of the replicated signals may be controlled by a shift signal. The spectral replication may be limited to single-sided replication that is either higher or lower in wavelength than the original photonic signal, but not both.

A complementary recursive replicater in accordance with the invention may combine two single-sided replicaters to replicate a photonic signal in both directions along a spectrum. The complementary recursive replicater may use two wavelength shifters within two recursive loops. One recursive loop may produce replicated copies that are shorter in wavelength than the original photonic signal. The other recursive loop may produce replicated copies that are longer in wavelength.

A four-wave-mixing replicater in accordance with the invention may spectrally replicate copies of a photonic signal by biasing an amplifier to operate in a non-linear region. The four-wave-mixing replicater may combine a mixing signal with the photonic signal. The mixing signal may include many wavelengths. The interaction of the mixing signal and the photonic signal within the amplifier may produce copies of the photonic signal at various wavelengths.

An apparatus and method for replicated-spectrum multiplexing in accordance with the invention may include a number of replicated-spectrum transceivers in a parallel configuration.

Each replicated-spectrum transceiver may replicate a photonic signal at many different wavelengths and filter out (i.e. pass through) a replicated copy at a unique wavelength. The filtered copies of various photonic signals may be combined to produce a multiplexed photonic signal.

An apparatus and method for long-haul transmission in accordance with the invention may include an unstable light source and a replicated-spectrum transceiver. The unstable light source such as a semiconductor diode may produce a photonic signal that has many spectral lines (i e. multi-modal resonances). The photonic signal may be too broad and too unstable for long haul transmission. The replicated-spectrum transceiver may spectrally convert the multi-modal source to a single-mode source (i.e. a single spectral line). The replicated-spectrum transceiver may also fold the multiple modes into a confined spectral band, effectively utilizing mode diversity to produce a statistically reliable narrowband photonic signal suitable for multiplexing and long-haul transmission.

An adaptive photonic transmitter in accordance with the invention may include a wavelength shifter and a pair of narrowband filters. The wavelength shifter may (adaptively) wavelength shift the unstable photonic signal to a desired wavelength and thereby provide a stabilized photonic signal. However, the stabilized photonic signal may be too broad for a particular application. The pair of narrowband filters may be offset such that only a portion of their passbands overlap. The stabilized photonic signal may pass through the offset narrowband filters to produce an ultra-narrowband photonic signal.

A matched-filter adaptive photonic transmitter in accordance with the invention may include one or two wavelength shifters and a pair of narrowband filters with matching (i.e. nearly identical) passbands. The first wavelength shifter may stabilize an unstable photonic signal. The first narrowband filter may bandpass the stabilized photonic signal to provide a narrowband signal. The second wavelength shifter may wavelength shift the narrowband signal such that only a portion of its spectrum remains within the passband of the pair of narrowband filters. The wavelength-shifted narrowband signal may pass through the second narrowband filter to produce an ultra-narrowband photonic signal.

### BRIEF DESCRIPTION OF THE DRAWINGS

The foregoing and other objectives and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of an embodiment of a wavelength shifting apparatus in accordance with the invention;

FIG. 2 is a schematic diagram of an embodiment of a quadrature Mach-Zehnder modulation device in accordance with the invention;

FIG. 3 is a graph of the Mach-Zehnder device transfer function in accordance with the embodiment of FIG. 2;

FIG. 4 is a schematic block diagram of an embodiment of a modulation synthesizer in accordance with the invention;

FIG. 5 is a schematic block diagram of an embodiment of a modulation synthesizer configured to perform ON/OFF keying in accordance with the invention;

FIG. 6 is a schematic diagram of an embodiment of a phase modulation device in accordance with the invention;

FIG. 7 is a schematic block diagram of an embodiment of a modulation synthesizer configured to perform frequency shift keying in accordance with the invention;

FIG. 8 is a schematic block diagram of an embodiment of a wavelength error detector in accordance with the invention;

FIG. 9 is a schematic block diagram of an embodiment of a tunable wavelength error detector in accordance with the invention;

FIG. 10 is a schematic block diagram of an embodiment of a tunable wavelength error detector in accordance with the invention;

FIG. 11 is a schematic block diagram of an embodiment of a channel allocation mechanism in accordance with the invention;

FIG. 12 is a schematic block diagram of an embodiment of a tunable wavelength stabilized transmitter in accordance with the invention;

FIG. 13 is a schematic block diagram of an embodiment of a recursive wavelength shifter in accordance with the invention;

FIG. 14 is a set of frequency domain graphs of several signals associated with one embodiment of the recursive wavelength shifter depicted in FIG. 13;

FIG. 15 is a schematic block diagram of an embodiment of a system for coherent wavelength-shift multiplexing in accordance with the invention;

FIG. 16 is a schematic block diagram of an embodiment of a wavelength-shifting transceiver in accordance with the invention;

FIG. 17 is a set of frequency domain graphs of several signals associated with the invention;

FIGS. 18a and 18b are schematic block diagrams of embodiments of full-duplex narrowband filters in accordance with the invention;

FIG. 19 is a schematic block diagram of an embodiment of a pseudo full-duplex narrowband filter in accordance with the invention;

FIG. 20 is a schematic block diagram of an embodiment of a full-duplex crossbar switch in accordance with the invention;

FIG. 21 is a schematic block diagram of an embodiment of a full-duplex wavelength-shifting switch element in accordance with the invention;

FIG. 22 is a schematic block diagram of an embodiment of a full-duplex wavelength-shifting switch in accordance with the invention;

FIG. 23 is a schematic block diagram of an embodiment of a replicated-spectrum transceiver in accordance with the invention;

FIG. 24 is a set of frequency domain graphs of several signals associated with the invention;

FIG. 25 is a schematic block diagram of an embodiment of a wavelength-shifting replicater in accordance with the invention;

FIG. 26 is a schematic block diagram of an embodiment of a recursive wavelength-shifting replicater in accordance with the invention;

FIG. 27 is a schematic block diagram of an embodiment of a complementary recursive replicater in accordance with the invention;

FIG. 28 is a schematic block diagram of an embodiment of a four-wave mixing replicater in accordance with the invention;

FIG. 29 is a schematic block diagram of an embodiment of a replicated-spectrum multiplexer in accordance with the invention;

FIG. 30 is a schematic block diagram of an embodiment of a long-haul transmission system in accordance with the invention;

FIG. 31 is a schematic block diagram of an embodiment of an adaptive photonic transmitter in accordance with the invention; and

FIG. 32 is a schematic block diagram of an embodiment of a matched-filter adaptive photonic transmitter in accordance with the invention.

### DETAILED DESCRIPTION OF THE PREFERRED EMBODIMENTS

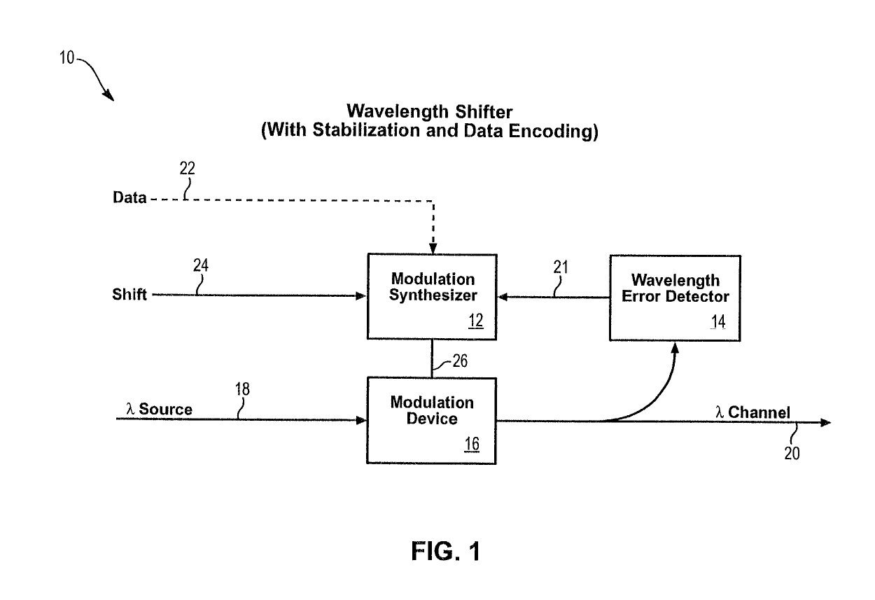

It will be readily understood that the components of the present invention, as generally described and illustrated in the Figures herein, may be arranged and designed in a wide variety of different configurations. Thus, the following more detailed description of the embodiments of the system and method of the present invention, as represented in FIGS. 1 through 30, is not intended to limit the scope of the invention. The scope of the invention is as broad as claimed herein. The illustrations are merely representative of certain, presently preferred embodiments of the invention. Those presently preferred embodiments of the invention will be best understood by reference to the drawings, wherein like parts are designated by like numerals throughout.

Those of ordinary skill in the art will, of course, appreciate that various modifications to the details of the Figures may easily be made without departing from the essential characteristics of the invention. Thus, the following description of the Figures is intended only by way of example, and simply illustrates certain example embodiments consistent with the invention as claimed.

The design, implementation and deployment of photonic systems involves the convergence of a number of disciplines each with their own working vocabularies. Additionally, the novelty of the present invention presents some new terms and concepts. Definitions of various terms are presented throughout the text for the reader's convenience.

In photonic systems, it is usually more convenient to refer to carriers in terms of wavelength rather than frequency. Despite this preference, channel spacing is usually expressed in frequency units rather than units of length. Throughout this description, the amount of wavelength shifting is expressed in terms of frequency (Hz) while the result (i.e. a change in carrier wavelength) is referred to as wavelength shifting. As used within this description, the term “wavelength shifting” refers to changing the wavelength of a photonic signal without converting the photonic signal to and from an electronic signal.

Referring to FIG. 1, specifically, while generally referring to all the Figures, a wavelength shifter 10 with wavelength stabilization and data encoding may include a modulation synthesizer 12, a wavelength error detector 14, and a modulation device 16. The modulation synthesizer 12 may produce a controlling waveform referred to as a modulation waveform 26. The modulation waveform 26 may have a variety of shapes including, but not limited to, sine waves, square waves, triangle waves, sawtooth waves and the like. The particular shape of the modulation waveform 26 may depend on the characteristics of the modulation device 16 such as the transfer function. The frequency of the modulation waveform 26 may depend on the amount of wavelength shifting.

The modulation synthesizer 12 may vary the modulation waveform 26 in response to various controls or signals and thereby effect certain changes to a photonic signal 18 including, but not limited to, encoding data, performing wavelength stabilization, or changing the wavelength pattern to that of a desired channel. In the depicted embodiment, the selected changes convert the photonic signal 18 to a channelized photonic signal 20.

The wavelength error detector 14 may monitor the channelized photonic signal 20 and provide an error signal 21 effective to correct and stabilize the wavelength of the channelized photonic signal 20. The modulation device 16 may modulate the photonic signal 18 with the modulation waveform 26 and provide the channelized photonic signal 20. The channelized photonic signal 20 may have a wavelength pattern corresponding to a desired channel. The wavelength pattern may define the desired wavelength (as a function of time) of the channel carrier.

The photonic signal 18 may be a multiple channel composite signal or a single channel non-composite signal. Multiple channel composite signals may contain a plurality of wavelengths, each with a unique wavelength pattern, while non-composite signals typically have a single wavelength pattern. Regardless of the complexity of the photonic signal 18, the modulation device 16 receives the photonic signal 18 and may provide the channelized photonic signal 20 with a wavelength pattern corresponding to a particular channel.

In selected embodiments, the modulation device 16 may be a full-duplex device capable of simultaneously modulating signals from both directions. In embodiments that include a modulation device 16 that is full-duplex, the wavelength shifter 10 may be also full-duplex. In full-duplex operation, the modulation device 16 receives the photonic signal 18 and provides the channelized photonic signals 20 in each direction. For simplicity, this description typically describes half-duplex operation even though full-duplex operation may be achievable with no changes to the depicted embodiments.

Under proper control, the wavelength shifter 10 may direct a single channel photonic input into any one of an arbitrary number of output channels. Multiple channel composite signals may be similarly directed. For example, a composite signal comprised of multiple wavelengths that are equally spaced by a fixed frequency interval, may be shifted up or down as a group by an arbitrary frequency to occupy a new set of wavelengths. Single channel non-composite signals and multiple channel composite signals may also be composed of dynamic wavelengths (e.g. of light or the like). Each wavelength may follow a prescribed pattern referred to herein as a wavelength pattern.

The wavelength shifter 10 may be designed to stabilize and channelize the photonic signal 18. Typically, the channelized photonic signal 20 has the same complexity as the photonic signal 18 and is a composite signal if the photonic signal 18 is a composite signal. The channelized photonic signal 20 differs from the photonic signal 18 in that the wavelengths of the photonic signal 18 may be shifted to match a wavelength pattern associated with a channel or a group of wavelength patterns associated with a group of channels. In some embodiments, the photonic signal 18 may also be associated with a wavelength pattern but it is generally assumed that the wavelength patterns typically originated externally and may be unknown to the system of interest.

The modulation synthesizer 12 may receive a data signal 22 and a shift signal 24. The data signal 22 is optional and is not present in certain embodiments. The modulation synthesizer may provide a modulation waveform 26 designed to channelize the photonic signal 18 via the modulation device 16.

The data signal 22 may be used to pre-modulate the modulation waveform 26, and thereby encode data into the channelized photonic signal 20. Pre-modulation is the act of modulating the modulation waveform. Pre-modulation facilitates the encoding of data by various techniques, including but not limited to, Frequency-Shift Keying, ON/OFF keying, code-division keying and the like.

Time-domain orthogonal codes may be directly used by the modulation synthesizer 12, when pre-modulating the modulation waveform. Orthogonal codes are patterns that do not interfere or correlate with each other. Various frequency-domain orthogonal codes, including but not limited to, frequency-shift-keying Walsh codes, may be converted to a time-domain waveform and used to pre-modulate the modulation waveform 26. Joint time-frequency codes may also be used to pre-modulate the modulation waveform 26. For example, one bits may be encoded by a positive frequency shift in an alternating ON-OFF-ON-OFF pattern, while zero bits may be encoded by a negative frequency shift in an alternating OFF-ON-ON-OFF pattern.

In the depicted embodiment, the various elements of the wavelength shifter 10 act in concert to effect certain results including but not limited to, encoding data, performing wavelength stabilization, changing the channel or channels of a photonic signal and the like. In the depicted embodiment, the modulation synthesizer 12 generates a modulation waveform 26 appropriate to achieve the desired results, such as wavelength shifting, data encoding, wavelength stabilization and the like. In the depicted embodiment, the modulation device 16 is typically driven by the modulation waveform 26, which effects the actual changes to the photonic signal 18 to produce the channelized photonic signal 20. Meanwhile, the wavelength error detector 14 may provide feedback to the modulation synthesizer 12 to correct wavelength errors.

The modulation synthesizer 12, the wavelength error detector 14, and the modulation device 16 may be selected and embodied to act together to achieve desired results. For example, the modulation device 16 may be a quadrature device requiring the modulation waveform 26 to be a quadrature waveform. Quadrature waveforms have two components that are substantially 90 degrees out of phase (i.e. when one component is rising or falling rapidly the other is plateauing).

The wavelength shifter 10 provides the ability to simultaneously encode data, channelize a photonic signal, and stabilize a photonic signal via a single modulation device. In certain embodiments, the data signal 22 is not used and the modulation synthesizer 12 may simply be a voltage-controlled quadrature oscillator. Other embodiments may not need wavelength stabilization and may omit the wavelength error detector 14.

The wavelength error detector 14 may monitor the channelized photonic signal 20 and provide a wavelength error signal 21 useful to correct wavelength errors in the channelized photonic signal 20. The wavelength error detector 14 may monitor the single channel of a non-composite photonic signal. The wavelength error detector 14 may also monitor a representative channel of a multiple channel composite signal.

Certain embodiments in accordance with the present invention may not independently shift and correct wavelength errors in all channels of a multiple channel composite signal using a single wavelength shifter 10. However, wavelength errors may be minimized in a multiple channel composite signal (using a single wavelength shifter 10) by generating a wavelength error signal that is the weighted average of the wavelength error of each channel. Typically, if a group of channels is derived from the same laser or light source, selecting a representative channel may be sufficiently effective to achieve the desired results and much less costly than generating an averaged wavelength error signal.

The wavelength shifter 10 enables stabilization of a single channel or group of channels without requiring direct control of a laser or light source. Separating stabilization from the actual laser device facilitates greater flexibility in designing and deploying photonic systems. Separating stabilization from the light source may also lower the cost of system deployment.

Separating the wavelength error detector 14 from the synthesis and modulation functions of the wavelength shifter 10 facilitates system design flexibility. Depending on the application, the wavelength error detector 14 may operate about a wavelength that is fixed or tunable. The wavelength error detector 14 may be dedicated to a single wavelength shifter 10 or shared among multiple wavelength shifters 10. The wavelength error detector 14 may also be dynamic and support wavelength patterns. Regardless of the application, the wavelength error signal 21 provides feedback to the modulation synthesizer 12, which may effect shifting, stabilization and channelization of the photonic signal 18.

Certain embodiments in accordance with the present invention use the modulation device 16 to shift and stabilize the wavelength of a carrier signal that is included in the photonic signal 18. In certain embodiments, data may also be encoded onto the carrier signal with the wavelength shifter 10 via the data signal 22. Various forms of data encoding may be performed, including without limitation frequency shift keying, amplitude modulation, and phase modulation and the like.

A shift signal 24 may control the extent by which a wavelength may be shifted by the wavelength shifter 10 (ignoring any wavelength error correction). The shift signal 24 may have a constant value corresponding to a desired amount of wavelength shifting. The shift signal 24 may also be a dynamic signal corresponding to a spreading or gathering function.

A spreading function is essentially a wavelength pattern that may be used to change fixed-wavelength channels to spread-spectrum channels. Spread-spectrum channels are channels having wavelength patterns that are typically very dynamic. Conversely, spread-spectrum channels may be converted to fixed-wavelength channels by using a gathering function. Spread-spectrum channels may be based on orthogonal functions. Orthogonal functions are patterns that do not correlate or interfere with each other. Selecting wavelength patterns that are orthogonal helps minimize interference between channels and allows multiple channels to overlap in wavelength.

Separating the shift signal 24 from the wavelength error signal 21 allows for greater control and flexibility of the wavelength shifter 10. Wavelength shifting of the photonic signal 18 may advantageously occur through either mechanism. For example, the shift signal 24 may correspond to a wavelength pattern, while the wavelength error signal 21 may provide fine tuning of the average wavelength of the channelized photonic signal 20. In the embodiments depicted in the FIGS. 1-11, the shift signal 24 and the wavelength error signal 21 may be equal and independent in their ability to effect a wavelength shift on the photonic signal 18 and thereby provide the channelized photonic signal 20.

The wavelength shifter 10 may be used to interface between systems with dissimilar channel wavelength patterns. For example, one system may use spread-spectrum channels while another may use channels with fixed wavelengths. By providing a spreading function or conversely an unspreading function to the shift signal 24, the wavelength shifter 10 may be used to convert fixed-wavelength channels to spread-spectrum channels and vice versa. Conversion between two spread-spectrum channels may occur by providing the difference of two spreading functions to the shift signal 24.

In certain embodiments, the shift signal 24 controls the amount of shift in units of frequency (Hz). In some embodiments, the shift signal 24 provides a shift range, facilitating wavelength error correction to occur within that range. Specifying a shift range on the shift signal 24, enables the wavelength shifter 10 to lock onto a particular channel when wavelength shifting a multiple channel composite photonic signal. Wavelength shifting a composite photonic signal without a shift range may result in channel wandering should a composite signal experience fading or some other kind of degradation.

The shift signal 24 may be data keyed instead of using the data signal 22. Data keying with the shift signal 24 effectively creates spread-spectrum or frequency domain data keying. Frequency shift keying is perhaps the simplest form of frequency domain data keying wherein the shift signal 24 alternates between two shift values to encode the data. The shift signal 24 may be data keyed with binary codes such as Walsh codes. Continuous codes may also be used to data key the shift signal 24.

The modulation device 16 may include a number of photonic pathways that carry copies of the photonic signal 18 that meet at a point of convergence. The various pathways of the photonic signal 18 may have different effective lengths (i.e. the number of wavelengths traveled may be slightly different). Changing the effective length of various pathways results in various degrees of constructive and destructive interference at the convergence point. By splitting photonic waves into multiple paths of various delays and recombining the split waves onto a single path, photonic devices and filters of various types may be created.

One element used in accordance with the invention is a phase modulator. Phase modulators often vary the index of refraction of a particular section of a waveguide and may be controlled with an applied voltage. Changing the index of refraction effectively changes the number of wavelengths traveled through a particular length of a medium ( i.e. the delay time of a pathway). An ability to dynamically control the delay of a path via an applied voltage adds additional power for processing photonic signals.

For example, a Mach-Zehnder modulator may split a photonic signal onto two complementary pathways of identical length, each with a phase modulator. With no applied voltage, the split photonic signals may arrive in phase (i.e. rising and falling in unison) and effectively sum to the original photonic signal. Symmetrically increasing the delay of one path and decreasing the delay of the other path (via the applied voltages) modulates the amplitude of the combined photonic signal. At a certain point the combined signals will be 180 degrees out of phase (i e. one signal will be rising while the other is falling) resulting in a zero amplitude signal known as a dark point.

Normally, amplitude modulation with a modulation waveform that is a sine wave produces dual side bands resulting in two copies of a signal, one at a comparatively short wavelength and one at a comparatively long wavelength. Quadrature modulation, also known as single-sideband modulation, involves using two modulators that operate 90 degrees out of phase (i.e. one modulation waveform plateaus while the other is at its steepest pitch). Each modulator produces dual sidebands. However, two of the sidebands cancel, while two of the sidebands sum to create a single sideband.

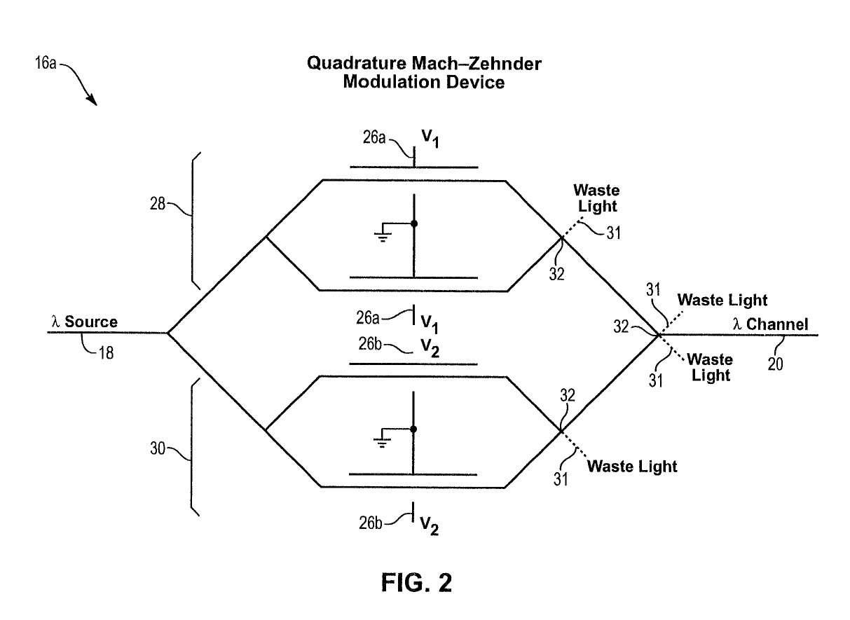

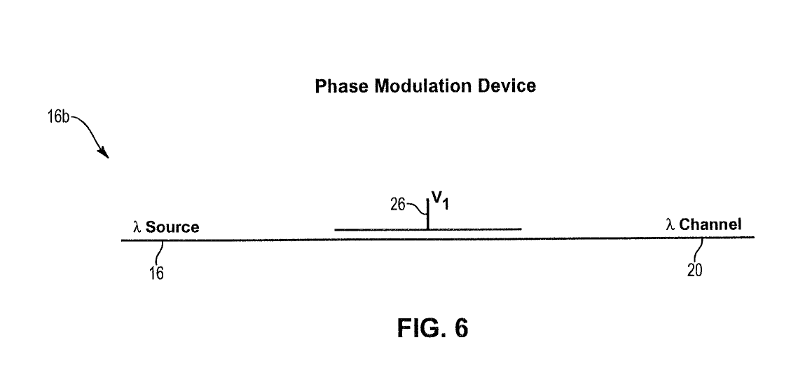

Various modulation devices may be suitable for the modulation device 16. Suitable devices may include a quadrature Mach-Zehnder modulation device 16a (see FIG. 2), a phase modulation device 16b (see FIG. 6), and a single Mach-Zehnder modulation device in concert with a phase modulation device 16b. Other possibilities may include, but are not limited to, a single Mach-Zehnder modulation device followed by a sideband filter, or a photonically driven device such as a stimulated Brillouin scatterer, a stimulated Raman scatterer, or a four-wave mixer. In certain embodiments, component cost may be reduced by selecting the modulation device 16 optimized for shifting within a specific frequency range.

Based on the foregoing, it will be readily apparent that other mechanisms for wavelength shifting may be constructed in accordance with the inventive principles set forth herein. It is intended, therefore, that the examples provided be viewed as exemplary of the principles of the present invention, and not as restrictive to a particular mechanism for implementing those principles.

Referring to FIG. 2, the modulation device 16 used in certain embodiments may be the quadrature Mach-Zehnder modulation device 16a. A quadrature device facilitates wavelength shifting by quadrature or single-sideband modulation. The quadrature Mach-Zehnder modulation device 16a may have an upper branch 28 and a lower branch 30. The upper branch 28 and the lower branch 30 may be complementary Mach-Zehnder modulators that perform in a quadrature mode, when driven by a modulation waveform 26 that is a quadrature waveform.

With a quadrature modulation device such as the quadrature Mach-Zehnder modulation device 16a, the modulation waveform 26 may have a quadrature waveform component 26a and a quadrature waveform component 26b. Waste light 31 may be emitted at a convergence point 32. In some embodiments, it may be desirable to use the waste light 31 from the convergence point 32 to perform phase stabilization or other useful functions. The photonic signal 18 may experience constructive and destructive interference at the convergence point 32. The result of the constructive and destructive interference may be amplitude modulation.

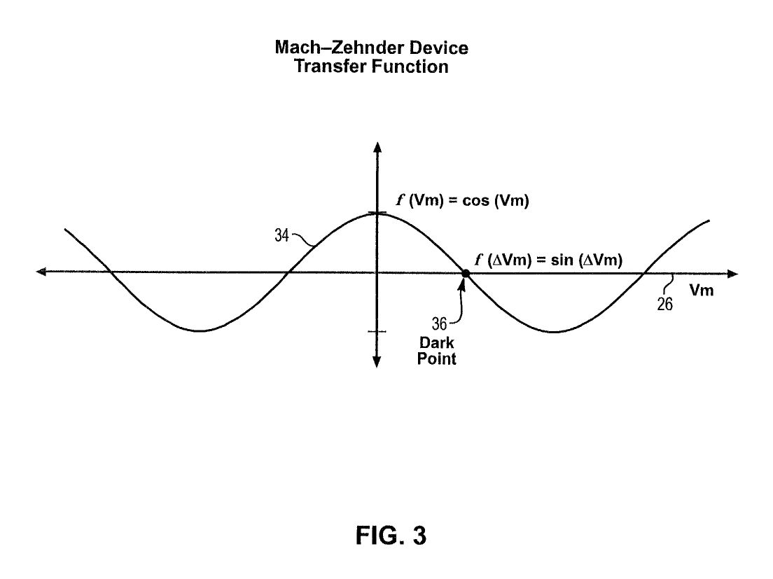

Referring to FIG. 3, while continuing to refer to FIG. 2, a transfer function 34 typical of the upper branch 28 and the lower branch 30 may be a function of the voltage or value of the modulation waveform 26. The transfer function 34 may correspond to a cosine wave. The transfer function 34, may describe the amount of constructive interference versus the voltage or value of the modulation waveform 26. In certain embodiments, the modulation synthesizer 12 may provide a modulation waveform optimized for a particular modulation device 16.

Proper biasing of (i.e. adding an offset to) the modulation waveform components 26a and 26b corresponding to the upper branch 28 and the lower branch 30, allow each branch to operate at a dark point 36. At the dark point 36 essentially no light may pass through the quadrature Mach-Zehnder modulation device 16a. Operating at or near the dark point 36 may be advantageous. Operating at or near the dark point 36 may reduce transmitted power and signal distortion.

In certain embodiments, applying a ramp function (a waveform of constant slope) beginning at the dark point 36 produces a transfer function 34 corresponding to a sine wave of negative polarity. Therefore, small fluctuations in quadrature waveform components 26a and 26b about the dark point 36, may produce modulations that substantially linear and bipolar (i.e. they are directly proportional to the fluctuations).

Small fluctuations in the quadrature waveform components 26a and 26b that are not biased to the dark point 36 may produce non-linear modulations. The non-linear modulations may not be directly proportional to the fluctuations in the quadrature waveform components 26a and 26b. For example the non-linear modulations may be unipolar with positive and negative fluctuations producing the same result. The transmitted power may also be substantially increased with no increase in signal effectiveness.

As shown in the transfer function 34, larger amplitude fluctuations in the modulation waveform 26 may also produce modulations that are non-linear (i.e. non-proportional to the modulation waveform 26). Such non-linearities as shown by the transfer function 34 may create noise harmonics (i.e. spurious wavelengths) in the channelized photonic signal 20. Noise harmonics in the channelized photonic signal 20 may be substantially eliminated by changing the shape of the modulation waveform components 26a and 26b.

Dividing the modulation waveform components 26a and 26b by the transfer function 34 may factor out the modulation non-linearities in the modulation device 16. For instance, driving (i.e. controlling) the depicted Mach-Zehnder quadrature modulation device 16a with waveform components 26a and 26b that are triangular or sawtooth in shape, may substantially eliminate the introduction of noise harmonics in the channelized photonic signal 20. To factor out the modulation non-linearities most effectively, the maximum and minimum amplitudes of the modulation waveform components 26a and 26b may need to be carefully controlled to correspond with the peaks and valleys in the transfer function 34.

Based on the foregoing, it will be readily apparent that the modulation synthesizer 12 may be embodied in a variety of forms including discrete circuitry, digital logic, software modules within a processor (with a digital-analog converter to drive the modulation device), and custom chips. Other mechanisms for modulation synthesis may be constructed in accordance with the inventive principles set forth herein. It is intended, therefore, that the examples provided be viewed as exemplary of the principles of the present invention, and not as restrictive to a particular mechanism for implementing those principles. Regardless of the implementation scheme selected, the modulation synthesizer 12 may be designed to drive the modulation device 16 as controlled by the error signal 21 and the shift signal 24. Implementation details may be quite specific to the modulation device used and other factors such as bandwidth, cost, and response time.

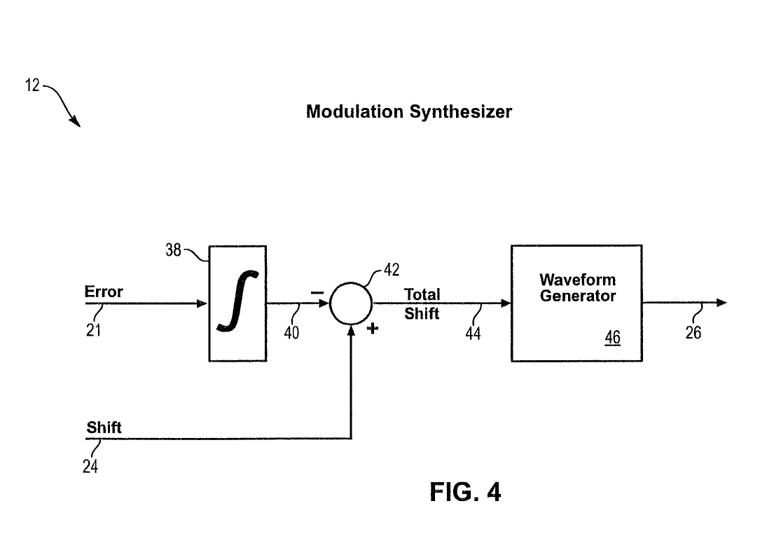

In particular, the method of data keying and the characteristics of the modulation device 16 may significantly affect the overall structure of the modulation synthesizer 12. With certain embodiments, it may be beneficial to embed data keying within the shift signal 24 (external to the modulation synthesizer 12). Other embodiments may data key within the modulation synthesizer 12. FIGS. 4, 5 and 7 show three examples of a modulation synthesizer 12 that share certain common design elements with unique changes relevant to the respective method of data keying and the characteristics of the modulation device 16 used by each example.

Referring to FIG. 4 a modulation synthesizer 12a may include an integration unit 3 8, a summing unit 42 and a waveform generator 46. The integration unit 38 and the summing unit 42 may work together to provide a total shift signal 44. The waveform generator 46 may provide a modulation waveform 26 that may induce a wavelength shift in the channelized photonic signal 20 (relative to the photonic signal 18) in proportion to the total shift signal 44.

The integration unit 38 may cause an integrated error signal 40 (and thereby the amount of wavelength shifting) to continually increase or decrease until the error signal 21 is essentially zero. The integration unit 38 may integrate the error signal 21 to provide the integrated error signal 40. In some embodiments, the integration unit 38 may optionally filter the integrated error signal 40 to control the response of the modulation synthesizer 12. For example, the error signal 21 may be low-pass filtered to dampen the response of the wavelength shifter 10 and prevent the integrated error signal 40 from overshooting a stable operating point.

Both the error signal 21 and the shift signal 24 may contribute to the amount of wavelength shifting encoded in the modulation waveform 26. The summing unit 42 may sum the shift signal 24 with the integrated error signal 40 to provide a total shift signal 44. The waveform generator 46 may encode a wavelength shift in the modulation waveform 26 in proportion to the total shift signal.

Any fluctuation in the shift signal 24 may pass directly to the total shift signal 44 resulting in a corresponding fluctuation in the amount of wavelength shifting encoded in the modulation waveform 26. In the depicted embodiment, providing a shift signal 24 that corresponds to a spreading or gathering function, encodes that spreading or gathering function into the modulation waveform 26. The modulation waveform 26 in turn may drive the modulation device 16, causing the wavelength shift to occur in the channelized photonic signal 20.

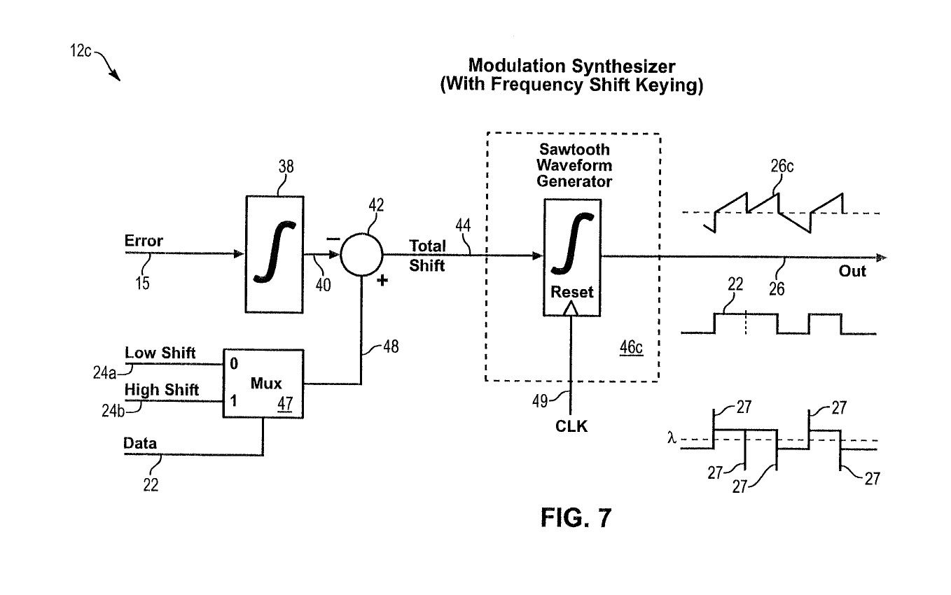

In some embodiments, it may be advantageous to constrain the range of wavelength shifting that may be encoded in the modulation waveform 26. In these embodiments, (such as shown in FIG. 7) the shift signal 24 may comprise a low shift 24a and a high shift 24b. The summing unit 42 may be configured to confine the total shift signal 44 to the range specified by the low shift 24a and the high shift 24b.

Continuing to refer to FIG. 4, the waveform generator 46 may receive the total shift signal 44 and generate the modulation waveform 26 relevant to the modulation device 16. The waveform generator 46 may encode a wavelength shift in the modulation waveform 26 in proportion to the total shift signal 44. Quadrature versions of the modulation device 16 may require a quadrature waveform with waveform components that are substantially 90 degrees out of phase.

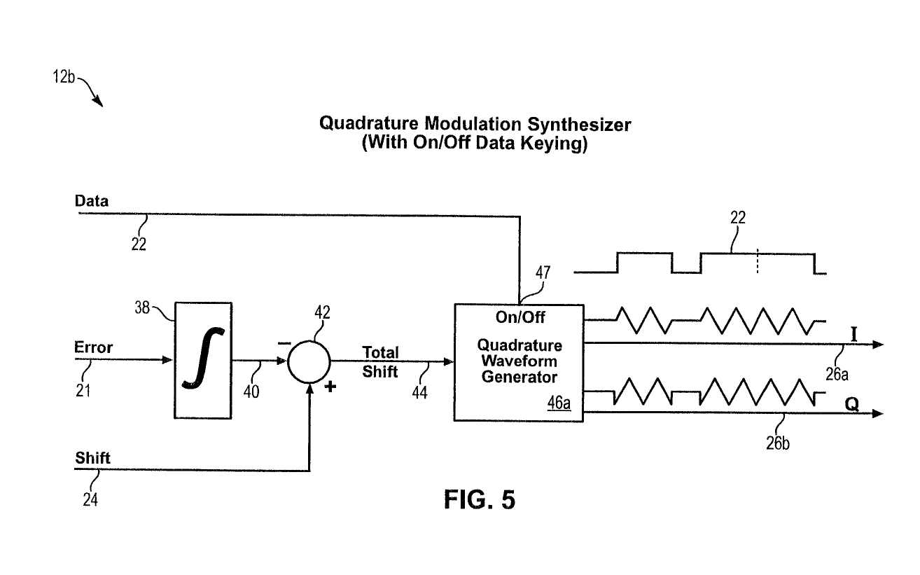

Referring to FIG. 5, a quadrature modulation synthesizer 12b may include a quadrature waveform generator 46a along with the integration unit 38 and the summing unit 42. The integration unit 38 and the summing unit 42 may work together to provide a total shift signal 44. The quadrature waveform generator 46a may generate a modulation waveform 26 comprised of quadrature waveform components 26a and 26b. The quadrature waveform components 26a and 26b may be encoded to induce a wavelength shift in a photonic signal in proportion to the total shift signal 44.

The quadrature waveform generator 46a may be optimized to drive a Mach-Zehnder quadrature modulation device 16a. The quadrature waveform generator 46a may generate quadrature waveform components 26a and 26b that reduce modulation non-linearities in the Mach-Zehnder quadrature modulation device 16a For example, the quadrature waveform components 26a and 26b may be triangular in shape with maximum and minimum amplitudes corresponding to the peaks and valleys of the transfer function 34.

Continuing to refer to FIG. 5, ON/OFF data keying may be added to the modulation synthesizer 12b by operably connecting the data signal 22 to an ON/OFF input 47 of the quadrature waveform generator 46a. Data keying may be accomplished by selectively setting the quadrature waveform components 26a and 26b to a value corresponding to the dark point 36 of the transfer function 34. For example, the upper branch 28 and the lower branch 30 may be operably set to the dark point 36 when the ON/OFF input 47 is in the OFF position.

Referring to FIG. 6, the phase modulation device 16b may differ from the quadrature Mach-Zehnder device 16a. For example, quadrature or single-sideband modulation may not be supported. Wavelength shifting may occur by applying an alternative waveform, such as a ramp function, to the input. In the illustrated embodiment, the extent of wavelength shifting provided by the phase modulation device 16b may be substantially proportional to the slope of the ramp function.

Assuming a photonic signal 18 of fixed wavelength, the phase modulation device 16b may be modeled as a photonic buffer or “queue” of varying length. The number of wavelengths or photonic cycles in the queue may be proportional to the voltage of the modulation waveform 26. Likewise, the rate by which photonic cycles are added to the queue may be proportional to the slope of the modulation waveform 26.

Following this train of thought further, the slope of the modulation waveform 26 may change the rate of photonic cycles leaving the queue. An increased rate of photonic cycles leaving the queue may require a shorter wavelength photonic signal, while a decreased rate of photonic cycles may require a longer wavelength photonic signal. From this model we may deduce that the phase modulation device 16b may wavelength shift by an amount that is proportional to the slope of the modulation waveform 26.

Sustaining a wavelength shift may be problematic with the phase modulation device 16b. A wavelength shift may require a modulation waveform 26 that maintains a constant slope. The modulation waveform 26 cannot indefinitely maintain a constant slope. Eventually a practical limit will be encountered. To reduce the need for sustained wavelength shifting and maintaining a constant slope, the modulation device 16b may be configured for frequency-shift keying. Several techniques may be used in conjunction with frequency-shift keying to ensure that finite limits may be maintained on the modulation waveform 26.

Techniques to ensure finite limits on the modulation waveform 26 may include, without limitation, encoding ones with positive frequency shift (a negative wavelength shift) and zeros with a negative frequency shift (a positive wavelength shift), limiting the one's density of the data stream to an acceptable range through various data encoding methods, and modifying circuits to substantially eliminate the DC terms of the data signal.

Referring to FIG. 7, a modulation synthesizer 12c may be configured to support frequency-shift keying with the phase modulation device 16b. Finite limits may be maintained on the modulation waveform 26 by driving the phase modulation device 16b with a sawtooth waveform 26c. The modulation synthesizer 12c may also be configured to encode the data signal 22.

As with the other modulation synthesizers 12, the modulation synthesizer 12c may include an integration unit 38, a summing unit 42 and a waveform generator 46. The integration unit 38 and the summing unit 42 may work together to provide a total shift signal 44. The waveform generator 46 may be a sawtooth waveform generator 46c. The sawtooth waveform generator 46c may provide a modulation waveform 26 that may induce a wavelength shift in a photonic signal in proportion to the total shift signal 44.

To enable data encoding by frequency-shift keying, the modulation synthesizer 12c may include a shift mux 47. The modulation synthesizer 12c may also have a shift signal 24 that is expanded to a low shift 24a and a high shift 24b. In the depicted embodiment, the low shift 24a and the high shift 24b may be negative and positive shifts, respectively, though not necessarily of the same magnitude.

A photonic apparatus, for example a multiplexer, may wavelength shift the same photonic source by unique amounts. The photonic apparatus may include multiple modulation synthesizers 12c. Each modulation synthesizer 12c may have unique values for the low shift 24a and the high shift 24b. The low shift 24a and the high shift 24b may correspond to a unique channel for each modulation synthesizer 12c.

The shift mux 47 may select either the low shift 24a or the high shift 24b as directed by the data signal 22. The low shift 24a may be selected when the data signal 22 corresponds to a zero bit. Likewise, the high shift 24b may be selected when the data signal 22 corresponds to a one bit. The selected shift may pass through the shift mux 47 as the data-keyed shift signal 48.

The summing unit 42, may sum the integrated error signal 40 with the data-keyed shift signal 48 to provide the total shift signal 44. By summing in the data-keyed shift signal 48, the total shift signal 44 may fluctuate in response to the data signal 22. Likewise, a wavelength shift may be encoded in the modulation waveform 26 in a pattern corresponding to the data signal 22.

A sawtooth waveform generator 46c may be a simple embodiment of the waveform generator 46 designed specifically to operate with the phase modulation device 16b. The modulation waveform 26 provided by the sawtooth waveform generator 46a may be restricted to a sawtooth wave. The sawtooth waveform generator 46 may generate a sawtooth waveform 26c by integrating the total shift signal 44 until reset (at regular intervals) by a clock signal 49.

The ramp portion of the sawtooth waveform may have a slope in proportion to the total shift signal 44. The clock signal 49 may reset the sawtooth waveform to a base value at regular intervals. The clock signal 49 may be synchronized with the data signal 22. The slope of the sawtooth waveform 26c may vary with the data signal 22. The data signal 22 may be encoded with the sawtooth waveform 26c.

The sawtooth waveform 26c may induce a wavelength spike 27 in a photonic signal. The wavelength spike 27 may be induced by vertical edges of the sawtooth waveform 26c. The duration of the wavelength spike 27 may be short enough to be irrelevant. The wavelength spike 27 may also move the wavelength of a photonic signal outside the transmission range of the system of interest. In some embodiments, therefore, the wavelength spike 27 may be harmless. In certain embodiments, the wavelength spike 27 may be advantageously used to provide a clock or synchronization signal within a distributed network of photonic equipment.

As mentioned previously, data keying may significantly affect the structure of the modulation synthesizer 12 specifically and the wavelength shifter 10 generally. It will be readily apparent that other mechanisms for data keying may be constructed in accordance with the inventive principles set forth herein. It is intended, therefore, that the examples provided be viewed as exemplary of the principles of the present invention, and not as restrictive to a particular mechanism for implementing those principles.

In certain embodiments data keying may involve placing a separate phase modulation device 16b in series with the modulation device 16. Other embodiments may involve modifying the modulation device 16 to receive a data keying signal separate from the (wavelength shifting and stabilizing) modulation waveform 26. In many embodiments, however, information to control data keying, wavelength shifting, and wavelength stabilization may be encoded in the modulation waveform 26.

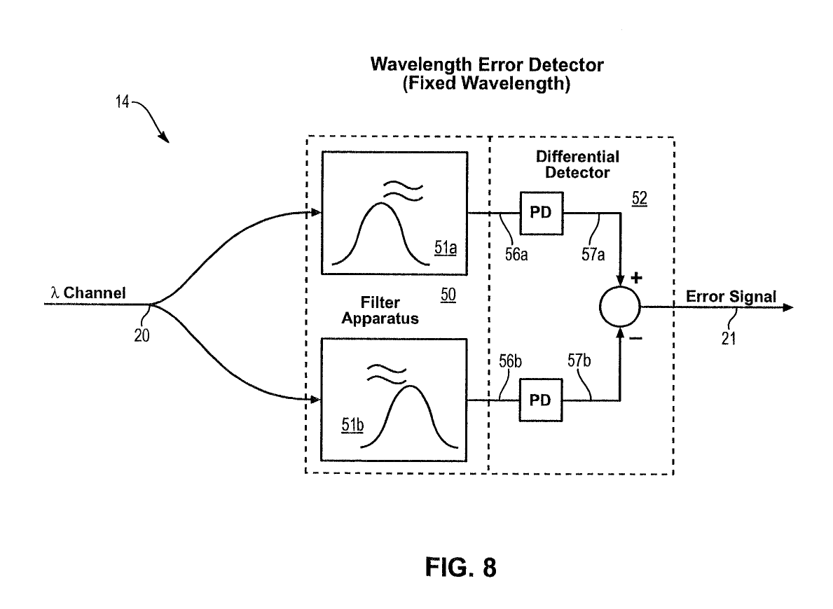

Referring to FIG. 8 specifically, while referring generally to all the Figures, a wavelength error detector 14 may include a filter apparatus 50 and a differential detector 52. The filter apparatus 50 may bandpass filter two copies of the channelized photonic signal 20 to provide a pair of filtered signals 56 to the differential detector 52. The differential detector 52 may process the pair of filtered signals 56 to provide an error signal 21. The wavelength error detector 14 may control the wavelength stabilization performed by the wavelength shifter 10 and in certain embodiments may significantly influence the effectiveness of the wavelength shifter 10.

In one embodiment the filter 50 may include a pair of filter devices 51a and 51b that may be slightly offset in wavelength. The pair of filter devices 51a and 51b may be manufactured from the same lot of material to better control their wavelength offset. The pair of filter devices 51a and 51b may provide a pair of filtered signals with intensities that are substantially equal when the channelized photonic signal 20 has a certain wavelength.

A differential detector 52 may detect differences of intensity in the pair of filtered signals 56 provided by filter devices 51a and 51b. The filter devices 51a and 51b may have a fixed bandpass wavelength. Fixed filter devices may be sufficient in some applications and may be Bragg filters. In some embodiments, tunable Bragg filters with slightly offset tuning inputs may increase the variety of wavelength patterns supportable with the wavelength error detector 14.

The differential detector 52 may include a pair of photo detectors and a comparator. Photodetectors may convert photonic signals to electrical signals. The pair of photo detectors within the differential detector 52 may convert the pair of filtered signals 56 to a pair of electrical signals 57. The comparator may produce the error signal 21 in proportion to the difference in intensities between the pair of electrical signals 57.

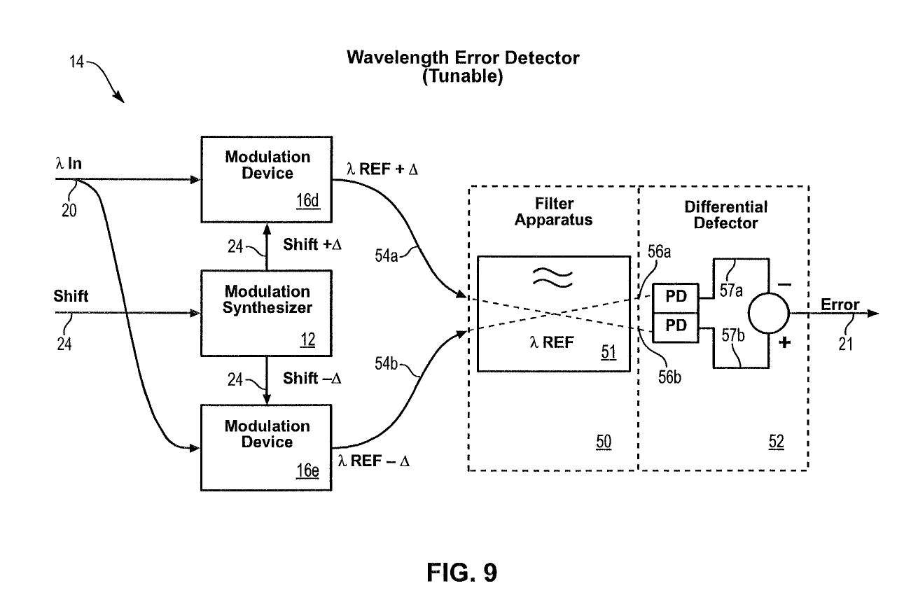

Referring to FIG. 9, a tunable version of the wavelength error detector 14 may include a complementary pair of modulation devices 16d and 16e configured to wavelength shift the channelized photonic signal 20 as directed by the modulation synthesizer 12. In one embodiment, the shift signal 24 carries a wavelength pattern corresponding to a wavelength pattern present on the channelized photonic signal 20.

The complementary pair of modulation devices 16d and 16e may be driven to wavelength shift by a common value corresponding to a wavelength pattern carried by the shift signal 24. Additionally, a slight wavelength offset may be produced between a shifted photonic signal 54a and a shifted photonic signal 54b. Wavelength shifting the channelized photonic signal 20 by slightly different amounts allows the use of a single filter device 51 in the filter apparatus 50 instead of the pair of matching filters devices 51a and 51b slightly offset in wavelength. Filter device 51 may be a standard Bragg filter.

The filter apparatus 50 may filter the shifted photonic signals 54a and 54b to provide the pair of filtered signals 56. The differential detector 52 may detect differences of intensity in the pair of filtered signals 56. The differential detector 52 may produce the error signal 21 in proportion to the intensity difference in the pair of filtered signals 56.

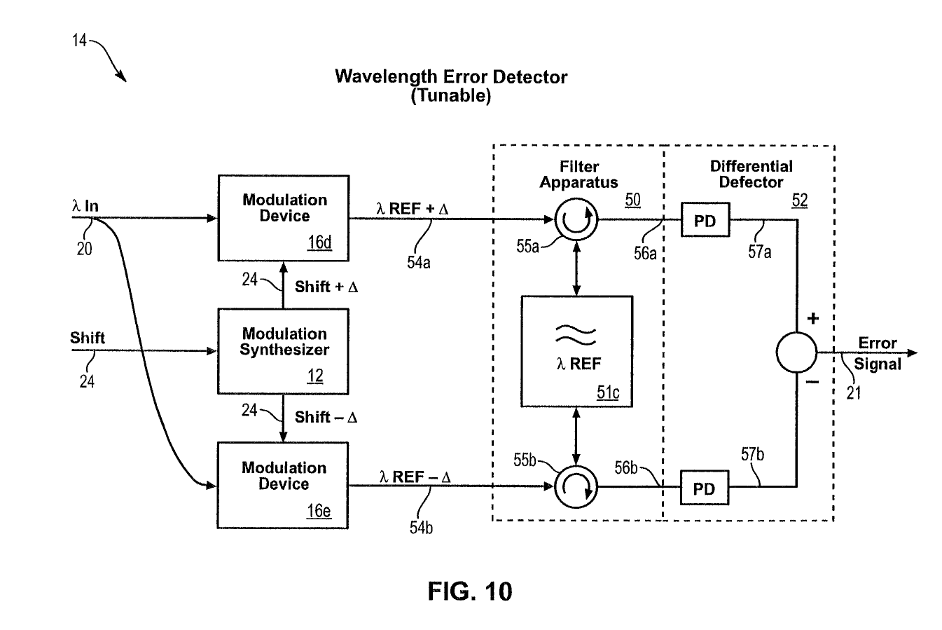

Referring to FIG. 10, another tunable version of the wavelength error detector 14 may include a filter apparatus 50 having a complementary pair of circulators 55a and 55b, and a bidirectional filter device 51c. The bidirectional filter device 51c may be a standard Bragg filter. The wavelength error detector 14 may also include the complementary pair of modulation devices 16d and 16e, and the differential detector 52.

The complementary pair of circulators 55a and 55b may direct the shifted photonic signals 54a and 54b to opposite ends of the bidirectional filter device 51c. The complementary pair of circulators 55a and 55b may also direct the reflected portion of the shifted photonic signals 54a and 54b to the differential detector 52. The differential detector 52 may produce an error signal 21 in proportion to the intensity differences in the reflected portion of the shifted photonic signals 54a and 54b.

The tunable versions of the wavelength error detector 14 depicted in FIGS. 9 and 10 may be designed to create a time-varying wavelength reference using a standard fixed filter device such as a Bragg filter. A time-varying wavelength reference may be very useful in deploying spread-spectrum channels. Spreading functions may be used to convert fixed-wavelength channels to spread-spectrum channels within the wavelength error detector 14. Gathering functions may also be used to convert spread-spectrum channels to fixed-wavelength channels within the wavelength error detector 14.

For example, the channelized photonic signal 20 received by the wavelength error detector 14 may have a wavelength pattern characterized by a spreading function. The complementary pair of modulation devices 16d and 16e may be driven by a modulation waveform characterized by a gathering function (corresponding to the spreading function). The pair of modulation devices may essentially unspread the channelized photonic signal 20 causing the shifted photonic signals 54a and 54b to be substantially fixed in wavelength. Having substantially fixed wavelengths for the shifted photonic signals 54a, 54b may facilitate using a standard fixed filter device such as a Bragg filter in the wavelength error detector 14.

Some wavelength variability between filter devices may be expected. Additionally, filter device wavelengths may often be temperature sensitive. In certain embodiments, temperature-dependent and device-dependent variations between standard filter devices 51 may be compensated. One method of compensation is to further adjust the value of the shift signal 24 of the modulation synthesizer 12 to account for temperature-dependent and device-dependent variations. Thus, a modulation synthesizer 12 may be a temperature-dependent device compensation mechanism. A temperature-dependent device compensation shift may be stored and accessed externally or internally to the modulation synthesizer 12.

In some embodiments, the wavelength error detector 14 (particularly the tunable versions), may be shared among multiple wavelength shifters 10. For example, the channelized photonic signals 20 from multiple wavelength shifters 10 may be combined onto a single photonic medium such as a fiber. On that photonic medium, a single wavelength error detector 14 may be configured to time-division multiplex between (i.e. scan) the various channels and provide a wavelength error signal 21 that is time-division-multiplexed. Additionally, the modulation synthesizer 12 may be configured to sample and hold the wavelength error signal 21 at a time-slot assigned to a particular channel.

Based on the foregoing, it will be readily apparent that other mechanisms for wavelength error detection may be constructed in accordance with the inventive principles set forth herein. It is intended, therefore, that the examples provided be viewed as exemplary of the principles of the present invention, and not as restrictive to a particular mechanism for implementing those principles.

The wavelength shifter 10 provides a convenient building block for creating photonic systems including transmission, switching and multiplexing equipment. Photonic data streams and/or photonic carriers arriving in a photonic signal 18 may be shifted, stabilized and channelized to become the channelized photonic signal 20. This may be done without conversion to the electronic domain. Photonic data rates and throughput may be maintained, while complex control features may be handled in the electronic domain.

Another feature of the wavelength shifter 10 is the ability to transparently pass the photonic signal 18 without knowledge of the encoding techniques or format used to create the photonic signal 18. The transparent nature of the wavelength shifter 10 and the ability to channelize photonic signals facilitates the transmission, multiplexing and switching of an extremely wide range of photonic signals.

The wavelength shifter 10 may also compensate for wavelength variability of existing photonic streams without remodulation and retransmission. Data may be previously encoded into the photonic signal 18 by upstream equipment, or data may be encoded onto the channelized photonic signal 20 for use downstream. Encoding may occur via the shift signal 24 or the data signal 22.

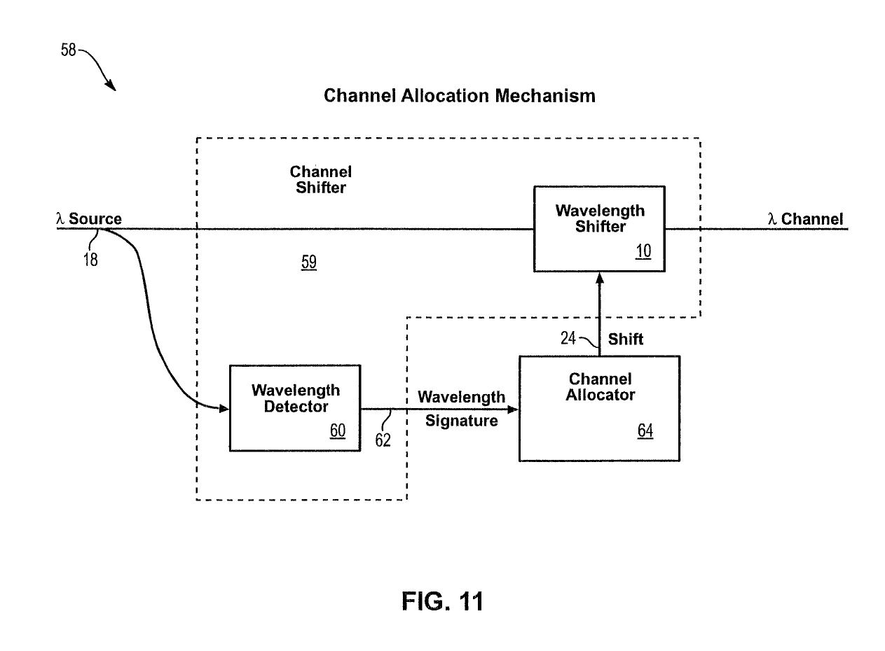

Referring to FIG. 11, a channel allocation mechanism 58 may automatically channelize and transparently transmit data-encoded photonic streams across a network of photonic equipment. The channel allocation mechanism 58 may not require prior knowledge of the carrier wavelengths and data encoding techniques. The channel allocation mechanism 58 may include a channel shifter 59 and a channel allocator 64. The channel shifter 59 and the channel allocator 64 may work together to wavelength shift a photonic signal to an available channel or group of channels.

The channel shifter 59 may have a wavelength detector 60 to receive the photonic signal 18, or the channelized photonic signal 20, and provide a wavelength signature 62. The channel shifter 59 may also include a wavelength shifter 10 configured to receive the photonic signal 18, or the channelized photonic signal 20, as an input and provide the channelized photonic signal 20 as an output. The photonic signal 18 and the channelized photonic signal 20 may be single channel non-composite signals or multiple channel composite signals.

The wavelength signature 62 is an information set that captures the essential elements of the wavelength of the photonic signal 18 and may include information such as the wavelength pattern, variance or signal jitter. The wavelength signature 62 may be useful when channelizing or multiplexing photonic signals from diverse sources. In certain embodiments, the wavelength signature 62 captures the essential wavelength characteristics of each carrier in a composite or non-composite photonic signal.

The channel allocator 64 may coordinate multiple channel shifters 59 and track available channels within a photonic system or a photonic network. A channel allocator 64 may be configured to receive the wavelength signature 62 and provide a shift signal 24 that directs the photonic signal 18 or the channelized photonic signal 20 into an available channel. In some embodiments, the channel allocator 64 may be shared by all the channel shifters 59 common to a system. Sharing the channel allocator 64 simplifies resource allocation, relieves contention, and resolves update and data synchronization issues. Multiple channel allocators 64 may also coordinate and update through a variety of methods.

One distributed method to coordinate and update multiple channel allocators 64 involves assigning a local pool of identified channels to each channel allocator. When a channel allocator exhausts the local pool of channels, a message may be sent to other channel allocators requesting borrowing of a channel from their pool. The request may be accommodated, brokered, negotiated, denied, or the like. Regardless of the method relied upon, the channel allocator 64 provides a shift signal 24 to the channel shifter 59. The channel shifter 59 shifts the photonic signal 18 or the channelized photonic signal 20 into an available channel.

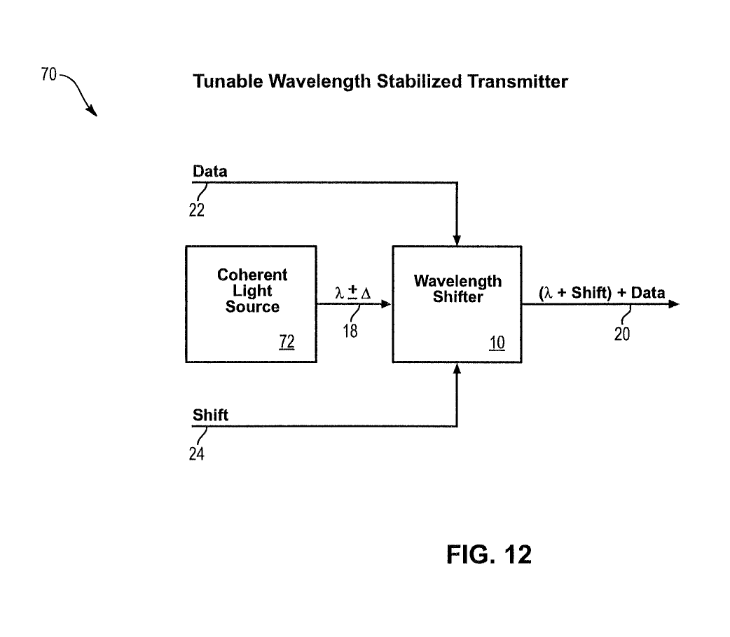

Referring to FIG. 12, a tunable photonic transmitter 70 may include a coherent light source 72 and a wavelength shifter 10. The photonic signal 18 provided by the coherent light source 72 may have a limited coherence length. The photonic signal 18 may have wavelength jitter sufficient to be unacceptable for a particular application. Additionally, the wavelength of the photonic signal 18 may be offset from the desired wavelength.

The tunable photonic transmitter 70 may shift and stabilize the photonic signal 18 via the wavelength shifter 10 to provide the channelized photonic signal 20. The tunable photonic transmitter 70 may also encode the data signal 22 into the channelized photonic signal 20. The channelized photonic signal 20 may be a spread-spectrum channel.

An ability to encode, shift, and stabilize the photonic signal 18 independent of the coherent light source 72 may provide additional benefits over standard photonic transmitting configurations. The coherent light source 72 need not be tunable, stable, or precise. The coherent light source 72 may be physically and electronically separated from the rest of the photonic transmitter 70.

In some embodiments, a single optical fiber may connect the coherent light source 72 with the wavelength shifter 10. Performance specifications of the channelized photonic signal 20 may be determined primarily by the electronic circuitry of wavelength shifter 10 rather than the photonic characteristics of the coherent light source 72. The performance characteristics of the coherent light source 72 may be largely unknown.

The wavelength shifter 10 adds considerable versatility to the photonic transmitter 70, including but not limited to, configuration options, data encoding, wavelength stabilization, fixed-wavelength channels, and spread-spectrum channels. A number of wavelength shifters 10 may share a single coherent light source 72. The photonic signal provided by the coherent light source 72 may be split into multiple photonic signals 18. Each wavelength shifter 10 may receive a photonic signal 18 and provide a channelized photonic signal 20. Each channelized photonic signal 20 may have a unique wavelength pattern. The channelized photonic signals 20 may be combined onto a single photonic medium, for example a fiber, to provide a multiplexed photonic signal.

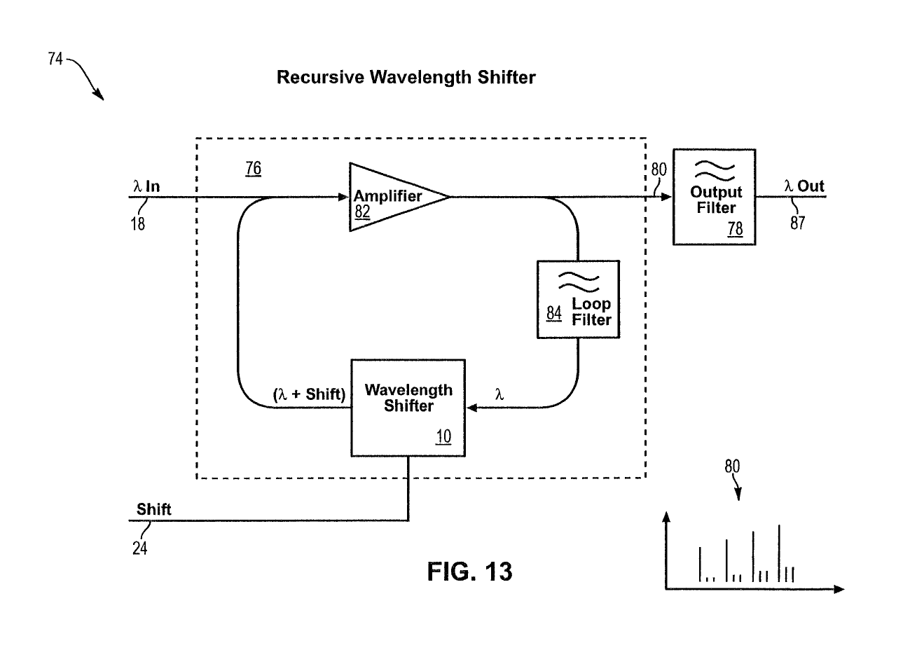

Referring to FIG. 13, a recursive wavelength shifter 74 may include a shifting loop 76 and an output filter 78. The shifting loop 76 may receive the photonic signal 18, having one or more wavelengths, and provide a photonic signal 18 with a spectral pattern 80. The spectral pattern 80 may have increasing or diminishing spectral tilt. The spacing and number of wavelengths of the spectral pattern 80 may be varied by the shift signal 24.

The shifting loop 76 may include an amplifier 82, a loop filter 84, and the wavelength shifter 10. The gain of the amplifier 82 may compensate for losses in the shifting loop 76 and contribute to the amount of spectral tilt in the spectral pattern 80. The loop filter 84 may shape the spectral pattern 80 with an arbitrary spectral envelope.

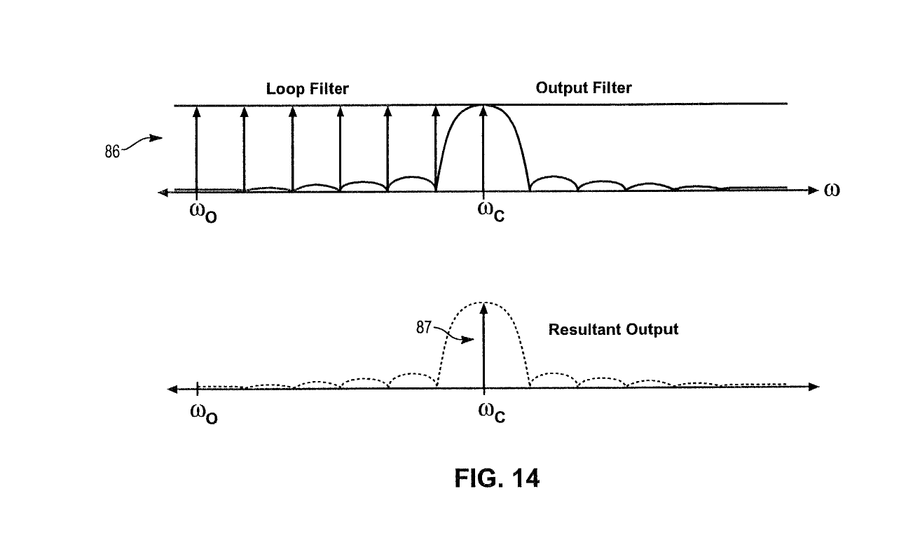

Referring to FIG. 14 while also referring to FIG. 13, in some embodiments the shifting loop 76 may effectively generate a spectral comb 86. The spacing of the “teeth” of the spectral comb 86 may be controlled by the shift signal 24. The photonic signal 18 may consist of a single spectral line, which is recursively replicated by the shifting loop 76 to generate the spectral comb 86. In other embodiments the spectral pattern 80 may be repeating and continuous instead of having discrete “teeth.” The shape of the repeating portion of the spectral pattern 80 may be provided by the photonic signal 18.

The output filter 78 may filter a photonic signal with the spectral pattern 80 to provide a spectrally shaped photonic signal 87. As shown in FIG. 14, the output filter 78 may select one tooth or region from the spectral pattern 80 and substantially suppress other teeth or regions of the spectral pattern 80. The recursive wavelength shifter 74 may include multiple output filters 78. Each output filter 78 may select a different tooth or region and provide a unique spectrally shaped photonic signal 87.

Based on the foregoing, it will be readily apparent that other mechanisms for recursive wavelength shifting may be constructed in accordance with the inventive principles set forth herein. It is intended, therefore, that the examples provided be viewed as exemplary of the principles of the present invention, and not as restrictive to a particular mechanism for implementing those principles.

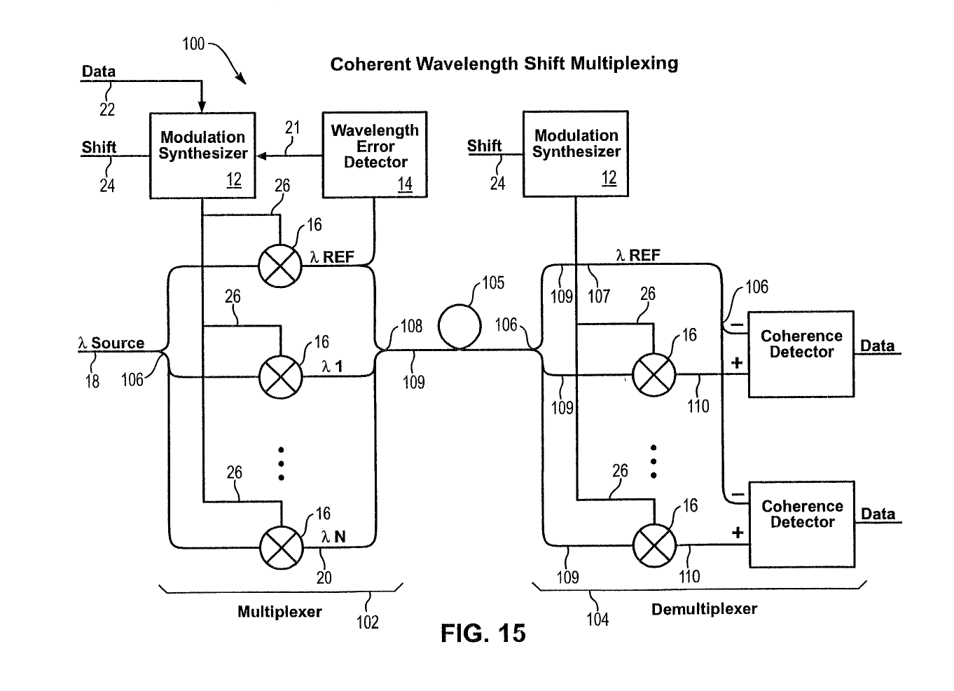

Referring to FIG. 15, a system for coherent wavelength-shift multiplexing 100 may include a coherent wavelength-shifting multiplexer 102 and a coherent wavelength-shifting demultiplexer 104. The coherent wavelength-shifting multiplexer 102 and the coherent wavelength-shifting demultiplexer 104 may be in close proximity or they may be in separate locations. In addition, they may also be directly connected or connected via a common network 105.

A number of channels may be available on the common network 105 or a portion thereof. Some of the channels on the common network 105 may be coherent channels, which require a reference channel for proper decoding. Coherent channels may be more robust than noncoherent channels in that the reference channel may facilitate decoding a signal with a lower signal-to-noise ratio (i.e. in a noisier environment). The common network 105 may be able to bear a greater number of coherent channels than non-coherent channels.

The coherent wavelength-shifting multiplexer 102 and the coherent wavelength-shifting demultiplexer 104 may connect to some or all of the coherent channels associated with the common network 105. The coherent wavelength-shifting multiplexer 102 may multiplex a number of channels onto the common network 105. Similarly, the coherent wavelength-shifting demultiplexer 104 may demultiplex a number of channels from the common network 105.

The coherent wavelength-shifting multiplexer 102 may include a splitter 106 that distributes the photonic signal 18 to a number of modulation devices 16. The photonic signal 18 may originate from a single coherent light source. The modulation synthesizer 12 may generate a set of modulation waveforms 26. Each modulation device 16 may modulate the photonic signal 18 with one of the modulation waveforms 26 to provide a channelized photonic signal 20.

Each modulation waveform 26 may be designed to shift the wavelength of the photonic signal 18 to a unique wavelength pattern associated with a channel. A shift signal 24 may be provided to control the amount of wavelength shifting. The shift signal 24 may be a composite signal with a unique wavelength pattern for each modulation device 16. Additionally, the shift signal 24 may include spreading functions associated with particular channels.

The modulation synthesizer 12 may also encode the data signal 22 into each of the channelized photonic signals 20. The data signal 22 may be a composite signal with a unique data stream for each channel to be encoded. The modulation synthesizer 12 may encode channels by pre-modulating the modulation waveform 26 controlling each modulation device 16. The modulation synthesizer 12 may pre-modulate data with a variety of methods including amplitude-shift keying or phase-shift keying.

Subsequent to wavelength shifting, each of channelized photonic signals 20 may be combined with a reference signal 107 via a combiner 108. The reference signal 107 may differ from the other combined photonic signals in that it is not encoded with the data signal 22. The reference signal 107 may carry a particular channel designated as the reference channel. The combiner 108 may combine the various channels onto a single transmission medium to provide a multiplexed photonic signal 109.

In coherent multiplexing systems and applications, each channel of the multiplexed photonic signal 109 is associated with a reference signal 107 that originates from the same coherent light source (i.e. the same photonic signal 18). In other words, each coherent multiplexer within the common network 105 provides a reference signal 107 in conjunction with the multiplexed photonic signal 109. The reference signal 107 may have a wavelength pattern associated with the reference channel. The reference signal 107 facilitates coherent detection within the coherent wavelength-shifting demultiplexer 104 or similar equipment.

Each of the channels generated by the coherent wavelength-shifting multiplexer 102 may be derived from the same photonic signal 18. Deriving all the channels from the same photonic signal 18 eliminates the variability associated with multiple sources. A single modulation synthesizer 12 may be used to generate all the channels combined into the multiplexed photonic signal 109. Using a common modulation synthesizer 12 for all the channels within a multiplexer may simplify the packing of channels within the multiplexed photonic signal 109 since each modulation waveform 26 may be derived from the same timing or frequency source.

The coherent wavelength-shifting multiplexer 102 may include a wavelength error detector 14. The wavelength error detector 14 may detect wavelength errors in the reference signal 107 and provide a wavelength error signal 21. Correcting wavelength errors in the reference signal 107, may correct and stabilize the wavelengths of all the channels combined into the multiplexed photonic signal 109. Correcting wavelength errors, may also reduce wavelength variation between multiple coherent light sources and facilitate denser channel packing in the common network 105.

The coherent wavelength-shifting multiplexer 102 may also be configured to detect wavelength errors in a representative channel or group of channels. In some embodiments, the wavelength error detector may time-division multiplex between some or all of the channels. Generally, however, correcting wavelength errors in the reference signal 107 is sufficient to correct and stabilize the wavelengths of all the channels.

The unique architecture of the coherent wavelength-shifting multiplexer 102 enables data encoding, channelization, stabilization, and multiplexing of a plurality of channels with a minimum amount of support circuitry. Additional channels and bandwidth may be provided by adding an appropriate number of the modulation devices 16 and increasing the number of modulation waveforms 26 synthesized by the modulation synthesizer 12. The control mechanisms for the coherent wavelength-shifting multiplexer 102 may be implemented in electronics to reduce complexity and cost, while the photonic signals remain in the photonic domain to achieve low latency, high bandwidth data transmission.

Similar in architecture to the coherent wavelength-shifting multiplexer 102, the coherent wavelength-shifting demultiplexer 104 may include a splitter 106 that distributes the multiplexed photonic signal 109 to a plurality of modulation devices 16. The modulation synthesizer 12 may generate a set of modulation waveforms 26 designed to wavelength shift the multiplexed photonic signal 109. Each modulation device 16 may modulate the multiplexed photonic signal 109 with a modulation waveform 26 to provide a normalized photonic signal 110.

The shift signal 24 may be a composite signal with a unique wavelength pattern for each channel in the multiplexed photonic signal 109. The shift signal 24 may include gathering functions corresponding to the spreading functions associated with particular channels. The gathering functions may “unspread” a spreading function and facilitate converting a spread sprectrum channel to a channel that is essentially fixed in wavelength.

Subsequent to wavelength shifting, each of the normalized photonic signals 110 may be compared with the multiplexed photonic signal 109 via a coherence detector 112. The normalized photonic signals 110 may each contain a channel that is coherent with the reference signal 107. The multiplexed photonic signal 109 includes the reference signal 107, enabling data to be extracted

The architecture of the coherent wavelength-shifting demultiplexer 104 enables demultiplexing, data decoding and de-channelization of a plurality of channels with a minimum amount of support circuitry. Additional channels and bandwidth may be supported by adding an appropriate number of the modulation device 16 and increasing the number of modulation waveforms 26 synthesized by the modulation synthesizer 12. The control mechanisms for the coherent wavelength-shifting demultiplexer 104 may be implemented in electronics to reduce complexity and cost.

Based on the foregoing, it will be readily apparent that other mechanisms for coherent wavelength-shift multiplexing and demultiplexing may be constructed in accordance with the inventive principles set forth herein. It is intended, therefore, that the examples provided be viewed as exemplary of the principles of the present invention, and not as restrictive to a particular mechanism for implementing those principles.

In many photonic systems it is desirable to transmit and receive on the same transmission medium. Transmitting and receiving on the same transmission medium is referred to as full-duplex communications. Full-duplex devices and components capable of bidirectional transmission may facilitate the deployment of full-duplex systems.

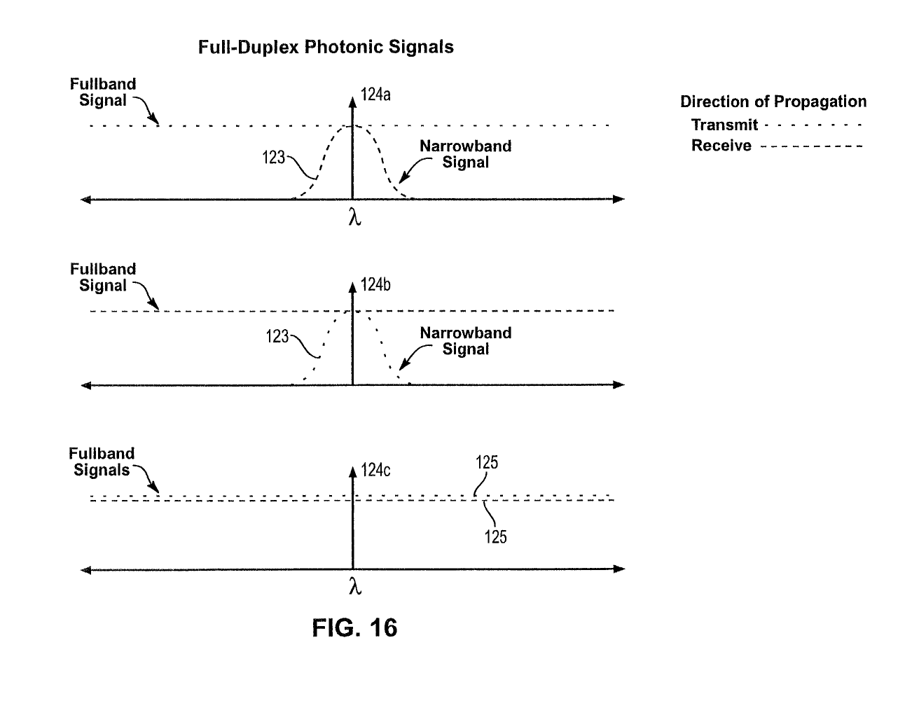

Referring to FIG. 16 while generally referring to all of the Figures, the full-duplex photonic signals 124a and 124b may include a narrowband signal 123 in one direction of propagation. The other direction of the full-duplex photonic signals 124a and 124b may be a fullband signal potentially including many channels or groups of channels across abroad spectral range. The narrowband signal 123 may include a single channel or a group of channels within a relative narrow spectral range.

Narrowband signals may be produced in photonic multiplexing and switching equipment as a result of extracting or filtering out a channel or group of channels from a fullband signal. Narrowband signals may be a single channel non-composite signal or a multiple channel composite signal. However, narrowband signals that are composite generally contain channels within a spectral region that have some degree of spectral propinquity. The channels need not be adjacent but are generally clustered within a spectral region that is much smaller than the entire spectrum of interest, i.e. the spectrum available to a fullband signal.

The narrowband signal 123 may propagate in opposite directions for the full-duplex photonic signals 124a and 124b. The full-duplex signal 124 and the half-duplex photonic signal 125 may be channelized similar to the channelized photonic signal 20 referenced in many of the Figures. The full-duplex signal 124c may have fullband signals propagating in both the transmit and receive directions.

The photonic signal 18 and channelized photonic signal 20 referenced in many of the Figures may be a full-duplex photonic signal 124 or a half-duplex photonic signal 125. The use of full-duplex or half-duplex ports, signals and channels may be application dependent. Specific details of various embodiments may be determined by selection of half-duplex or full-duplex communications.

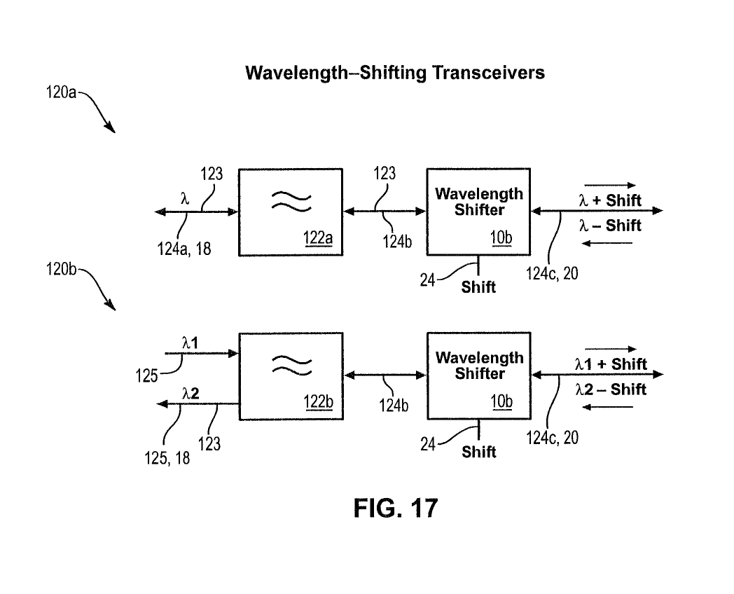

Referring to FIG. 17, a wavelength-shifting transceiver 120 is useful as a building block for various types of photonic switching, multiplexing and transmission equipment. The wavelength-shifting transceiver 120 may include a narrowband filter 122 and a wavelength shifter 10. The narrowband filter 122 may essentially operate as a channel selector while the wavelength shifter 10 may function as a channel changer. The narrowband filter 122 and the wavelength shifter 10 may be full-duplex .

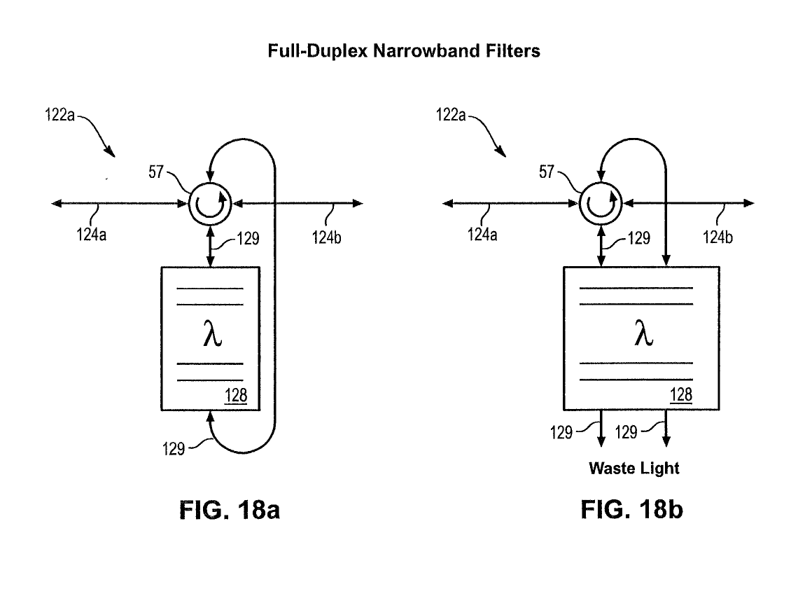

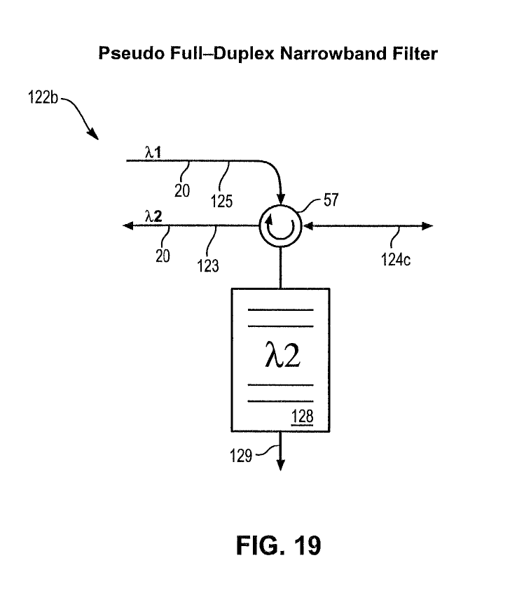

The narrowband filter 122 may operate as a channel selector by isolating a narrowband signal from a fullband photonic signal. The narrowband filter may be a full-duplex filter with transmit and receive signals propagating in opposite directions along a photonic path. FIGS. 18 and 19 show various embodiments of the narrowband filter 122.

Continuing to refer to FIG. 17, the wavelength-shifting transceiver 120 may include a wavelength shifter 10b. The wavelength shifter 10b may be a full-duplex shifter capable of bidirectional wavelength shifting. The wavelength shifter 10b may shift the wavelength of the narrowband signal, converting the narrowband signal to and from a channelized photonic signal 20. The channelized photonic signal 20 may have wavelength patterns that are fixed or dynamic.

Multiple channelized photonic signals may be combined or separated by the wavelength-shifting transceiver 120. Narrowband photonic input signals may be extracted and multiplexed from a plurality of photonic paths to provide a multiplexed photonic signal. Multiplexed photonic signals may be demultiplexed to provide a plurality of narrowband photonic output signals. Photonic switches may be constructed by cascading multiplexers and demultiplexers. Full-duplex and half-duplex embodiments may be supported by the present invention.

Continuing to refer to FIG. 17, a wavelength-shifting transceiver 120a may include the narrowband filter 122 and the wavelength shifter 10b. The narrowband filter 122 may determine the passband of the wavelength-shifting transceiver 120. The wavelength-shifting transceiver 120 may transmit and receive on channels with wavelength patterns that may be symmetric about the passband wavelength. The wavelength shifter 10b may convert signals within the passband of the narrowband filter 122 to and from a particular channel or group of channels.

The narrowband filter 122 may be fixed or tunable. The narrowband filter 122 may isolate a narrowband signal 123 from a photonic signal. The narrowband filter 122 may be a full-duplex filter that isolates a narrowband signal 123 from two fullband photonic signals propagating in opposite directions along aphotonic path. The passband of the narrowband filter 122 may be sufficiently broad to contain a plurality of channels.

The wavelength shifter 10b and the modulation device 16 used within the wavelength shifter 10b may also be full-duplex. Full-duplex components facilitate sending and receiving a full-duplex photonic signal 124. The full-duplex photonic signal 124 may include two half-duplex photonic signals 125 propagating in opposite directions along a photonic path or medium.

Referring again to FIG. 17, a wavelength-shifting transceiver 120b may differ from transceiver 120a by including a narrowband filter 122b that may not be completely full-duplex. The narrowband filter 122b may have 2 half-duplex ports each bearing a half-duplex photonic signal 125 and a full-duplex port bearing a full-duplex photonic signal 124c.

The narrowband filter 122 may be embodied in various forms depending on the type of ports required for a given application. Some applications may require ports that support full-duplex signals while other applications may only require half-duplex ports. Some applications may require ports that support composite photonic signals potentially including many channels while others may suffice with single channel ports. The embodiment of the narrowband filter 122 may change considerably depending upon the application. FIGS. 18 and 19 show various embodiments of the narrowband filter 122.

Referring to FIG. 18a, the narrowband filter 122a may include a circulator 57 and a reflecting filter 128. The reflecting filter 128 may be a Bragg filter. The circulator 57 may circulate one direction of the full-duplex photonic signals 124a and 124b to the reflecting filter 128 (one to each end). The reflecting filter 128 may reflect signals of a certain wavelength back to the circulator 57. The circulator 57 may circulate the reflected signals to the full-duplex photonic signals 124a and 124b. The reflected signals may be narrowband signals 123.

The reflecting filter 128 may also pass a pair of unreflected signals 129 to the photonic path at the opposing end of the filter. The unreflected signals may be directed to the circulator 57. The circulator 57 may circulate the unreflected signals 129 to the full-duplex photonic signals 124a and 124b. The unreflected signals 129 may propagate in the opposite direction along the same photonic path from which they originated. The unreflected signals 129 may add noise to the full-duplex photonic signals 124a and 124b.

Referring to FIG. 18b, another embodiment of the narrowband filter 122a may also include a circulator 57 and a reflecting filter 128. The reflecting filter 128 may be a Bragg filter. The circulator 57 may circulate signals propagating in one direction of the full-duplex photonic signals 124a and 124b to the reflecting filter 128. The reflected signals may be reflected back to the circulator 57. The circulator 57 may circulate the reflected signals to rejoin the full-duplex photonic signals 124a and 124b.

Continuing to refer to FIG. 18b, the unreflected signals 129 may propagate along different paths through the reflecting filter 129. In some embodiments, the different paths may be substantially parallel. Unlike the narrowband filter depicted in FIG. 18a, the unreflected signals 129 will not add noise to the full-duplex photonic signals 124a and 124b. In the narrowband filter 122a depicted in FIG. 18b, the unreflected signals 129 may be considered waste light.

Referring of FIG. 19, certain embodiments of the narrowband filter 122 may not be completely full-duplex. The narrowband filter 122b may have 2 half-duplex ports and a full duplex port. One of the half-duplex ports may be a transmit port, the other may be a receive port. The half-duplex ports together may essentially comprise a full-duplex port.

The transmit and receive ports may carry a channelized photonic signal 20. The narrowband filter 122b may also have a full-duplex port bearing a full-duplex photonic signal 124c. A circulator 57 may present one direction of the full-duplex photonic signal 124c to the reflecting filter 128. The circulator 57 may circulate a half-duplex photonic signal 125 to the full-duplex photonic signal 124 without narrowband filtering. In certain embodiments filtering only one direction of propagation of the full-duplex photonic signal 124c may be sufficient.

The various versions of the narrowband filter 122 depicted in FIGS. 18 and 19 use a circulator 57 that has four ports. A four-port circulator may not be available off-the-shelf. The circulator 57 may be a custom made device. Two three-port devices may be configured to provide four-port functionality. Four port circulators facilitate full-duplex filtering. Four ports also facilitate configurations that use just one reflecting filter 128. Using a single reflecting filter reduces the variation in wavelength between transmit and receive pathways for full-duplex filters. Half-duplex filters may get use off-the-shelf three-port circulators.

Full-duplex filters and components such as wavelength shifters may be advantageous in that photonic pathways may be leveraged to communicate in both directions. Full-duplex systems may reduce the cost of deploying a photonic network. Photonic bandwidth may potentially be doubled by upgrading existing half-duplex networks to full-duplex capability.

As mentioned previously, the wavelength-shifting transceiver 120 is useful as a building block for various types of photonic switching, multiplexing and transmission equipment. It will be readily apparent that various devices may be constructed in accordance with the inventive principles set forth herein. It is intended, therefore, that the examples provided be viewed as exemplary of the principles of the present invention, and not as restrictive to a particular application for implementing those principles.

The specific embodiment of the wavelength-shifting transceiver 120 generally, and the narrowband filter 122 specifically, may be dependent upon the application. One obvious factor is the use of full-duplex or half-duplex ports. Another factor is the complexity of the photonic signals used within an application. Single channel photonic signals may not require filtering. Composite photonic signals with more than one channel may require certain channels to be removed before continued transmission.

Based on the foregoing, it will be readily apparent that other mechanisms for narrowband filtering and wavelength-shift transceiving may be constructed in accordance with the inventive principles set forth herein. It is intended, therefore, that the examples provided be viewed as exemplary of the principles of the present invention, and not as restrictive to a particular mechanism for implementing those principles.

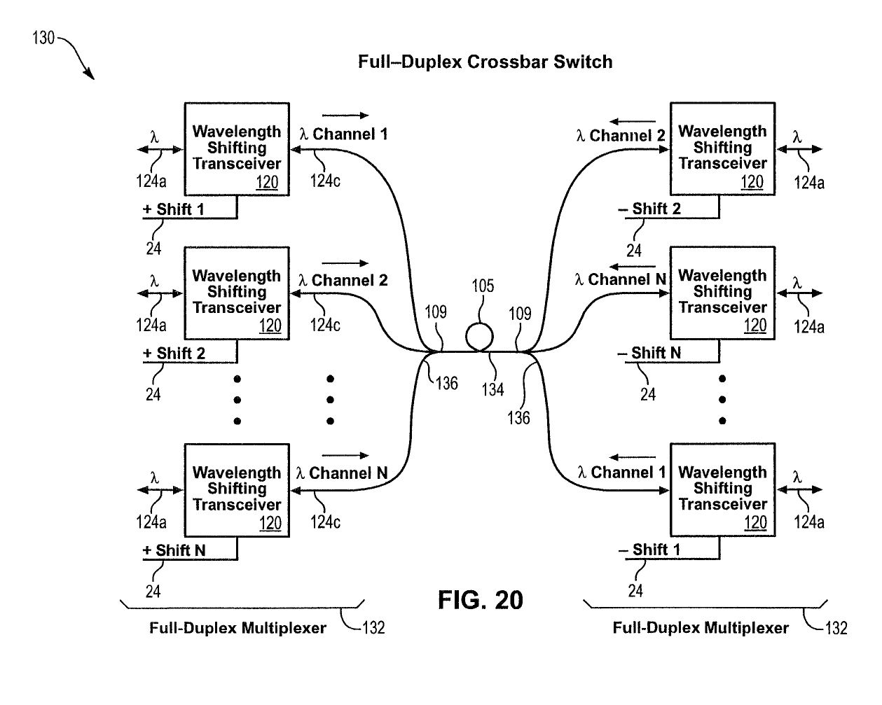

Referring to FIG. 20, a full-duplex crossbar switch 130 uses the wavelength-shifting transceiver 120 as a building block. The full-duplex crossbar switch 130 may include a pair of full-duplex multiplexors 132. The full-duplex multiplexors 132 may be identical and symmetrically oriented such that their multiplexed ports 109 may be photonicly connected via a photonic pathway 134.

The photonic pathway 134 may include a common network 105 that connects a wide variety of photonic equipment. The common network 105 may be a wide-area network or a local-area network. The full-duplex multiplexors 132 may also be co-located at the same facility or they may be geographically separated.

Each full-duplex multiplexor 132 may include one or more wavelength-shifting transceivers 120 connected to a combiner-splitter 136. The wavelength-shifting transceivers 120 may make a virtual connection by transmitting and receiving on a pair of common channels. In certain embodiments, the wavelength-shifting transceivers 120 may have passband wavelengths that are substantially identical.

Virtual connections may be made when a sender (i.e. a transmitter) encodes data on a particular channel and a receiver decodes that same data by listening on that same channel. Virtual connections may be a cost efficient replacement to a direct connection. The wavelength-shift transceiver 120 is capable of full-duplex virtual connections.

A pair of virtually connected transceivers exchange data with one another on a pair of designated channels. A virtual connection may be altered by changing the wavelength patterns assigned to the shift signal 24 of the wavelength-shifting transceiver 120. The shift signals 24 of virtually connected transceivers may have patterns that are substantially equal in magnitude and opposite in polarity. The shift signal 24 may correspond to a wavelength pattern associated with a particular channel.

The wavelength patterns assigned to the shift signals 24 within the full-duplex crossbar switch 130 may control the connecting or switching of ports thereof. In certain embodiments, one of the full-duplex multiplexers 132 may have a wavelength pattern permanently assigned to the shift signal 24 of each wavelength-shifting transceiver 120. The other full-duplex multiplexer 132 may assign wavelength patterns based on the desired virtual connections.

In certain embodiments an arbitrary number of full-duplex multiplexers 132 may be connected to a common network 105. The common network 105 may be a ring network. Each full-duplex multiplexers 132 may be connected such that each full-duplex multiplexer 132 transmits to, and receives from, the common network 105. In these embodiments, each wavelength-shifting transceiver 120 may broadcast a photonic signal to every wavelength-shifting transceiver 120 attached to the common network 105.

Broadcasting may simplify the deployment of the common network 105. Routing and packet switching may be eliminated in a broadcast environment. The common network 105 need not track senders and receivers or manage configuration and topology information. A wavelength-shifting transceiver 120 may listen to a particular broadcast by assigning a wavelength pattern (to the shift signal 24) that is equal in magnitude and opposite in polarity to that of the particular broadcast channel.

As simple as broadcasting is from a deployment point of view, networks based on broadcasting may reach a point of saturation. The desired traffic load on a broadcast network may exceed the bandwidth or capacity thereof. The ability to switching and route channels is needed to expand the number of sender and receivers accessible on a network.

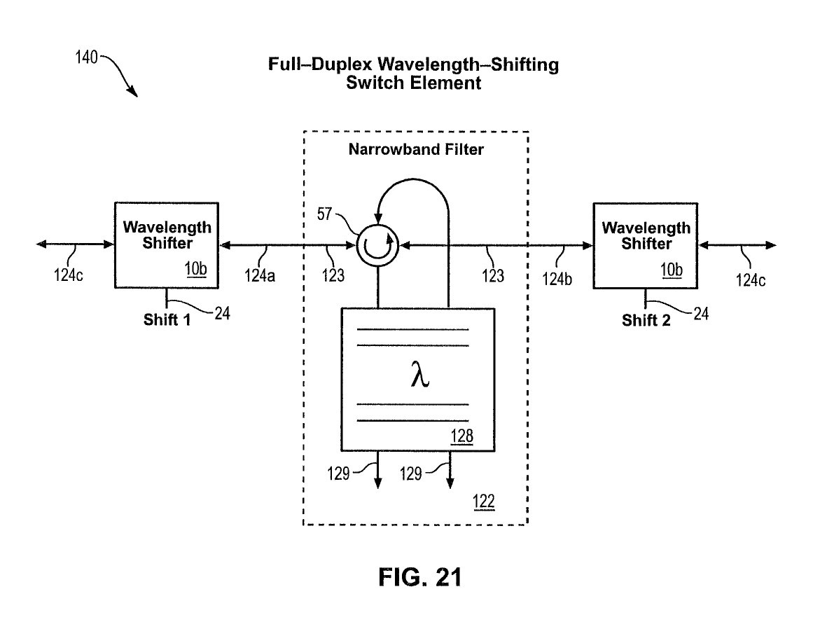

Referring to FIG. 21, a channel switching element 140 may be created by placing two wavelength-shifting transceivers 120 back-to-back and sharing a narrowband filter 122. Similar to the wavelength-shifting transceiver 120, the channel switching element 140 is usefull as a building block for various types of photonic switching, multiplexing and transmission equipment. The channel switching element 140 may be full-duplex.

The channel switching element 140 may include two wavelength shifters 10b and the narrowband filter 122. The wavelength shifters 10b may essentially operate as full-duplex channel changers. The narrowband filter 122 may essentially function as a full-duplex channel filter. The channel switching element 140 may facilitate virtual connections between two networks.

Each wavelength shifter 10b may wavelength shift a selected channel to and from a connecting channel or group of channels. The connecting channel or group of channels may correspond with a narrowband signal 123 (i.e. one direction of the full-duplex photonic signals 124a and 124b). The narrowband filter 122 may pass the narrowband signal 123 along each direction of propagation thru the channel switching element 140. The passband of the narrowband filter may be sufficiently broad to contain a plurality of connecting channels.

The wavelength shifters 10b may wavelength shift the connecting channels within the passband of the narrowband filter 122 to and from a set of arbitrary channels. The wavelength shifting ability of the channel switching element 140 facilitates connecting a channel or set of channels on one photonic path with a channel or set of channels on another photonic path. The virtual connections facilitated by the channel switching element 140 may be full-duplex connections.

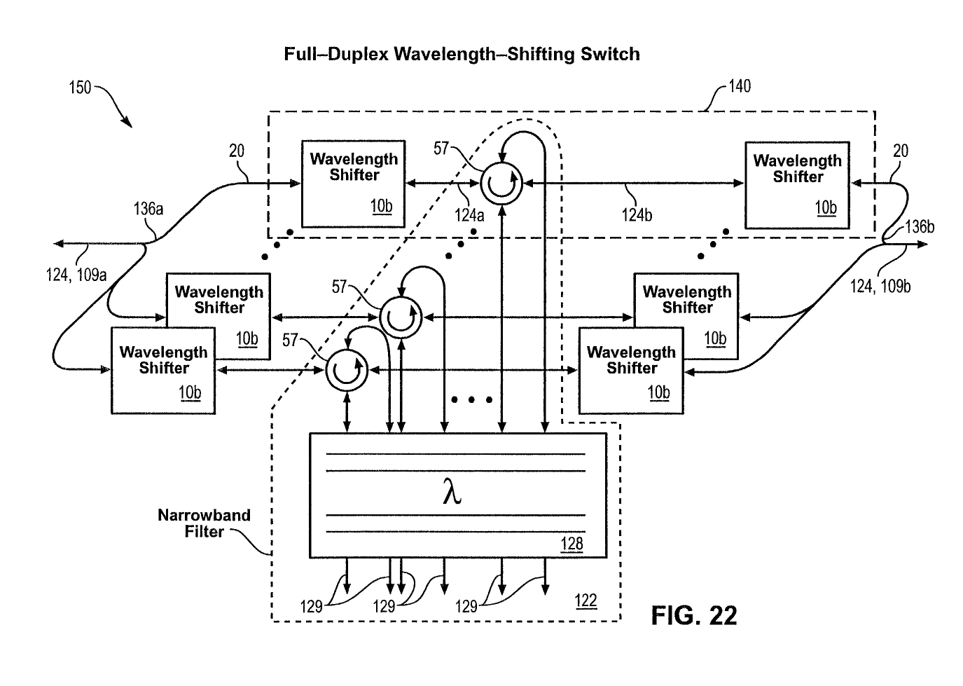

Referring to FIG. 22, a full-duplex wavelength-shifting switch 150 may include a plurality of channel switching elements 140 and the combiner-splitters 136a and 136b. Each channel switching element 140 may connect a channel or group of channels from a multiplexed photonic signal 109a with a channel or group of channels from a multiplexed photonic signal 109b. The virtual connections created by full-duplex wavelength-shifting switch 150 may be full-duplex connections.

Switching systems often have a complexity that increases in proportion to the channel capacity squared. The full-duplex wavelength-shifting switch 150 may have a linear complexity that increases in proportion to the channel capacity. The connection capacity of the full-duplex wavelength-shifting switch 150 may be increased by adding additional channel switching elements 140 and increasing the size of the combiner-splitters 136a and 136b. One full-duplex virtual connection may be made by each channel switching element 140. The virtual connection may be a channel or a group of channels. The architecture of the full-duplex wavelength-shifting switch 150 may be characterized as a scalable architecture.

The channel switching elements 140 may include a narrowband filter 122 and a pair of wavelength shifters 10. The narrowband filter 122 essentially operates as a channel selector while each wavelength shifter 10 functions as a channel changer. Each wavelength shifter 10 may shift the wavelength of the narrowband signal, converting the narrowband signal to and from a channelized photonic signal 20. The channelized photonic signal 20 may have wavelength patterns that are fixed or dynamic.

The narrowband filter 122 and the wavelength shifter 10 may be full-duplex. The combiner-splitters 136a and 136b may also be full-duplex in the sense that they split in one direction of propagation and combine in the other. The combiner-splitters 136a and 136b may combine the channelized photonic signals 20 to provide the multiplexed photonic signals 109a and 109b. The combiner-splitters 136a and 136b may also split the multiplexed photonic signals 109a and 109b to provide the channelized photonic signals 20. The multiplexed photonic signals 109a and 109b and the channelized photonic signals 20 may be full-duplex signals.

In some embodiments, the channel switching elements 140 may share a single narrowband filter 122. The narrowband filter 122 may include a plurality of pairs of full-duplex photonic ports. Each full-duplex photonic port pair may connect to a circulator 57. All the circulators in the narrowband filter 122 may also connect to a single reflecting filter 128. Sharing a single reflecting filter 128 may reduce the variation in passband wavelength between the photonic ports of the narrowband filter 122.

Virtual connections may be made with the full-duplex wavelength-shifting switch 150. The full-duplex wavelength-shifting switch 150 may virtually connect the photonic paths bearing the multiplexed photonic signal 109a and the multiplexed photonic signal 109b. The multiplexed photonic signals 109a and 109b may be full-duplex signals. Virtual connections may be made by assigning wavelength patterns to the wavelength shifter 10b corresponding to a channel on the multiplexed photonic signal 109a or 109b. The wavelength shifters 10b may wavelength shift the connecting channels within the passband of the narrowband filter 122 to and from a group of arbitrary channels.

Based on the foregoing, it will be readily apparent that other mechanisms for channel switching may be constructed in accordance with the inventive principles set forth herein. It is intended, therefore, that the examples provided be viewed as exemplary of the principles of the present invention, and not as restrictive to the particular devices for implementing those principles.

One issue in photonic systems is the instability of lasers and other photonic sources. Stable photonic sources are often expensive and may require additional feedback to stabilize the photonic signal sufficiently for a particular application. High performance, high precision active components may be required in many applications. In particular, multiplexing and switching require stable sources to avoid collisions between channels.

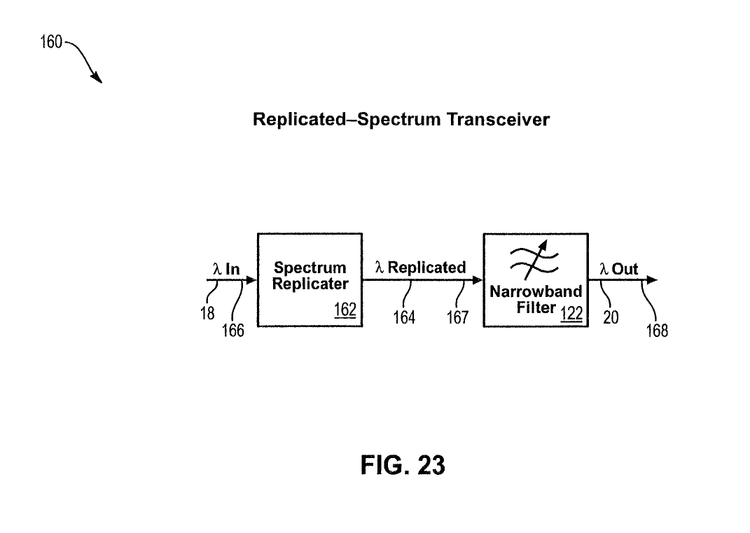

Referring to FIG. 23, a replicated-spectrum transceiver 160, may be a mechanism for stable photonic transmission and retransmission that uses mainly passive comparatively low-cost components. The replicated-spectrum transceiver 160 may include a spectrum replicater 162 and a narrowband filter 122. The spectrum replicater 162 may receive a photonic signal 18 that is unstable. The spectrum replicater may create multiple copies of the photonic signal 18. The narrowband filter 122 may pass at least one copy of the photonic signal 18 to provide a channelized photonic signal 20 that is stable.

The photonic signal 18 may include a single channel non-composite signal or a multiple channel composite signal. The spectrum replicator 162 may fill a very broad spectrum with copies of the photonic signal 18 to provide a replicated photonic signal 164 that covers an entire spectrum of interest. A variety of mechanisms may be employed to embody the spectrum replicater 162, including wavelength-shifting, recursive wavelength-shifting, and four-wave mixing.

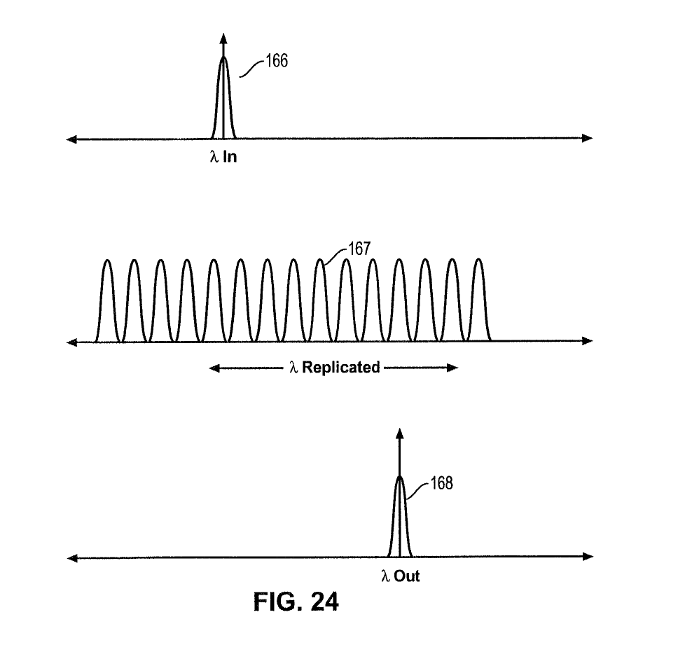

Referring to FIG. 24, the photonic signal 18 may have a narrowband spectrum 166. The replicated photonic signal 164 may have a replicated spectrum 167. The replicated spectrum 167 may be densely packed such that little unused bandwidth remains between replicated copies of the photonic signal 18. The replicated copies may have the same instability as the original photonic signal 18. The channelized photonic signal 20 may have a channelized spectrum 168.

The narrowband filter 122 may be sufficiently broad such that at least one replicated copy of the photonic signal 18 passes through the narrowband filter 122 to provide the channelized photonic signal 20. The stability of the channelized photonic signal 20 may be independent of the stability of the photonic signal 18 and the spectrum replicater 162. The wavelength of the channelized photonic signal 20 may be restricted to the passband of the narrowband filter 122 resulting in a very stable signal.

There may be many benefits to using a passive device such as the narrowband filter 122 to determine the wavelength stability of the channelized photonic signal 20. Passive devices may be less complex, less costly, more reliable, and more stable than active devices. The passband of the narrowband filter 122 may be much more stable than the wavelength of the photonic signal 18. Despite these advantages, the passband of the narrowband filter 122 may be dependent on the temperature of a reflecting filter 128. The temperature of the reflecting filter 128 may be held constant by using a Peltier device. Other standard mechanisms may increase the stability of the narrowband filter 122.

The replicated-spectrum transceiver 160 benefits directly from the stability of the narrowband filter 122. Due to its replicating feature, the replicated-spectrum transceiver 160 produces a channelized photonic signal 20 whose wavelength is very stable. The wavelength of the channelized photonic signal 20 is largely independent of the wavelength and the stability of the photonic signal 18.

Stability and wavelength independence facilitates using the replicated-spectrum transceiver 160 within many legacy photonic systems without express knowledge of all the characteristics of the photonic signal 18. Setup and deployment issues may be minimized. Stability and wavelength independence also enhance the versatility of the replicated-spectrum transceiver 160. The replicated-spectrum transceiver 160 enables the interfacing of short-haul or low-precision legacy equipment with long-haul or densely-multiplexed new equipment.

In certain embodiments, the narrowband filter 122 may be more narrow than the narrowband spectrum 166. In these embodiments, the narrowband filter 122 may pass less than one replicated copy of the original photonic signal 18. However, the narrowband filter 122 may pass a replicated copy of at least one channel of the original photonic signal 18. The narrowband filter 122 may be tuned to select a desired channel or group of channels from the replicated photonic signal 164. The stability of the photonic signal 18 may be an issue in these embodiments.

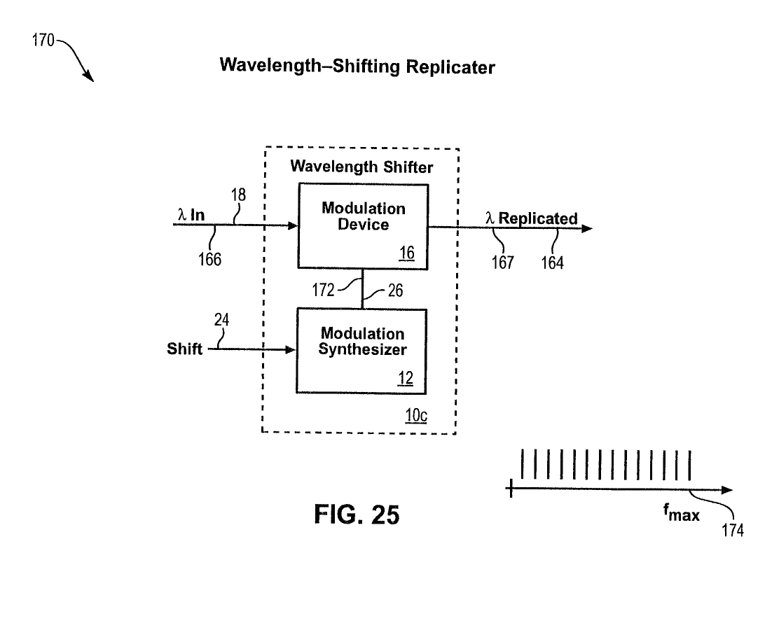

The architectural simplicity of the replicated-spectrum transceiver 160 facilitates a wide variety of embodiments. The narrowband filter 122 may also be embodied through a variety of mechanisms including without limitation Bragg filters, acoustic Bragg filters, temperature controlled fiber gratings and the like. Certain embodiments may be tunable to an arbitrary wavelength. A variety of mechanisms may be employed to embody the spectrum replicater 162, including without limitation, wavelength-shifting, recursive wavelength-shifting, four-wave mixing, and the like. FIGS. 25-28 highlight a variety of embodiments for the spectrum replicater 162.

Referring to FIG. 25, a wavelength-shifting replicater 170 may be embodied with a wavelength shifter 10c. The wavelength-shifter 10c may modulate the photonic signal 18 with a harmonic rich modulation waveform 172 to provide the replicated photonic signal 164. The harmonic rich modulation waveform 172 may have a harmonic rich spectrum 173 such as the spectrum depicted in FIG. 25. Each harmonic of the harmonic rich modulation waveform 172 may produce at least one copy of the photonic signal 18 within the replicated photonic signal 164.

The wavelength-shifter 10c may include a modulation synthesizer 12 and a modulation device 16. Since the replicated photonic signal 164 need not be particularly stable, the wavelength-shifter 10c may omit a wavelength error detector 14 and a wavelength error signal 21. Many replicated copies of the photonic signal 18 may be desirable. The modulation device 16 need not be a single-sideband or quadrature modulation device. The modulation device 16 may be double-sideband device that replicates copies on each side of the narrowband spectrum 166. Double-sideband devices may be less complex and less expensive than single-sideband or quadrature modulation devices.

The modulation synthesizer 12 may provide a modulation waveform 26. In order to produce multiple copies of the photonic signal 18, the modulation waveform 26 may be the harmonic rich modulation waveform 172. Each harmonic of the harmonic rich modulation waveform 172 may correspond to a copy of the photonic signal 18 within the replicated photonic signal 164.

The bandwidth 174 of the modulation device 16 may limit the replication range of the wavelength-shifter 10c. The frequency of the harmonics within the harmonic rich modulation waveform 172 may also be limited by the bandwidth 174 of the modulation device 16. The modulation device 16 may also limit the maximum slope in the modulation waveform 26. The phase of the harmonics within the harmonic rich modulation waveform may be adjusted to reduce the maximum slope in the modulation waveform 26.

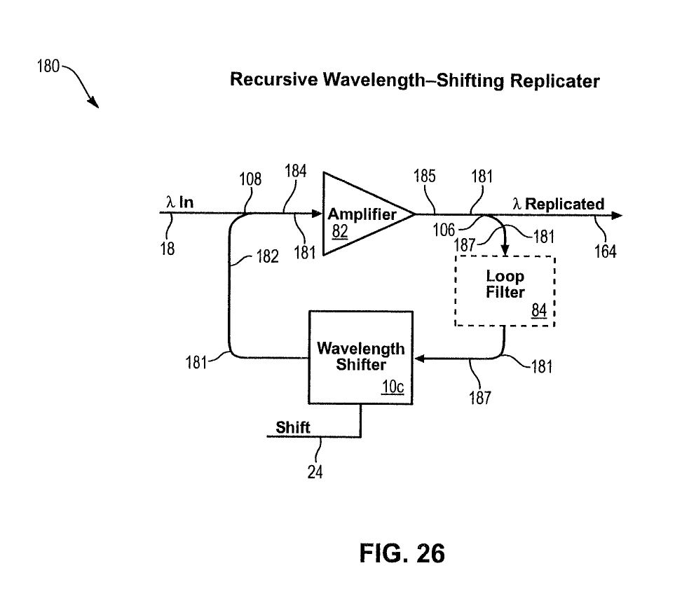

Referring to FIG. 26, a recursive wavelength-shifting replicater 180 may increase the replication range achievable with a limited bandwidth modulation device. The recursive wavelength-shifting replicater 180 may recursively wavelength-shift a photonic signal 18. Recursive wavelength shifting may place spectral copies of the photonic signal 18 at equal intervals within the replicated spectrum 167. The recursive wavelength-shifting replicator 180 may be very similar to the recursive wavelength shifter 74 shown in FIG. 13.

The recursive wavelength-shifting replicater 180 may include a combiner 108, an amplifier 82, a splitter 106, a wavelength shifter 10c, and, optionally, a loop filter 84. The components of the recursive wavelength-shifting replicater 180 may be interconnected within a shifting loop 181. Each pass through the shifting loop 181 may add an additional copy of the photonic signal 18 to the replicated photonic signal 164. The replicated copies of the photonic signal 18 may maintain a fixed spacing while drifting with the photonic signal 18.

The combiner 108 may combine the photonic signal 18 with a shifted signal 182 to provide a combined signal 184. The amplifier 82 may add gain to the combined signal 184 and provide an amplified photonic signal 185. The amplifier 82 may compensate for losses within the shifting loop 181 of the recursive wavelength-shifting replicater 180.

The splitter 106 may split the amplified photonic signal 185 into a replicated photonic signal 164 and a feedback signal 187. The feedback signal 187 may be wavelength shifted by the wavelength shifter 10c to provide the shifted signal 182. The feedback signal 187 may also be filtered by the loop filter 84. The loop filter 84 may directly limit the wavelength of the feedback signal 187 and thereby also limit the wavelength of the replicated photonic signal 164.

The recursive wavelength-shifting replicater 180 may be used to generate the replicated spectrum 167 that spans a vary broad range. The replicated spectrum 167 may be a spectral comb. The recursive wavelength-shifting replicater 180 may produce copies of the photonic signal 18 in only one direction along the replicated spectrum 167.

The recursive wavelength-shifting replicater 180 may facilitate converting signals in the 1310 nm range to the 1550 nm range or vice versa. A positive wavelength shift (negative frequency shift) may convert 1310 nm signals to 1550 nm signals. A negative wavelength shift (positive frequency shift) may convert 1550 nm signals to 1310 nm signals.

The recursive wavelength-shifting replicater 180 may produce copies of the photonic signal 18 in only one direction along the replicated spectrum 167. Using a double-sideband modulation device may produce positive and negative wavelength shifts with each pass through the shifting loop. However, there may be issues when using a double-sideband modulation device. For example, a photonic signal may experience a positive wavelength shift in one pass and a negative wavelength shift in a subsequent pass of the shifting loop. The result may be a time-delayed copy of the original signal. The time-delayed copy may arrive, however, out of phase and cancel the original signal.

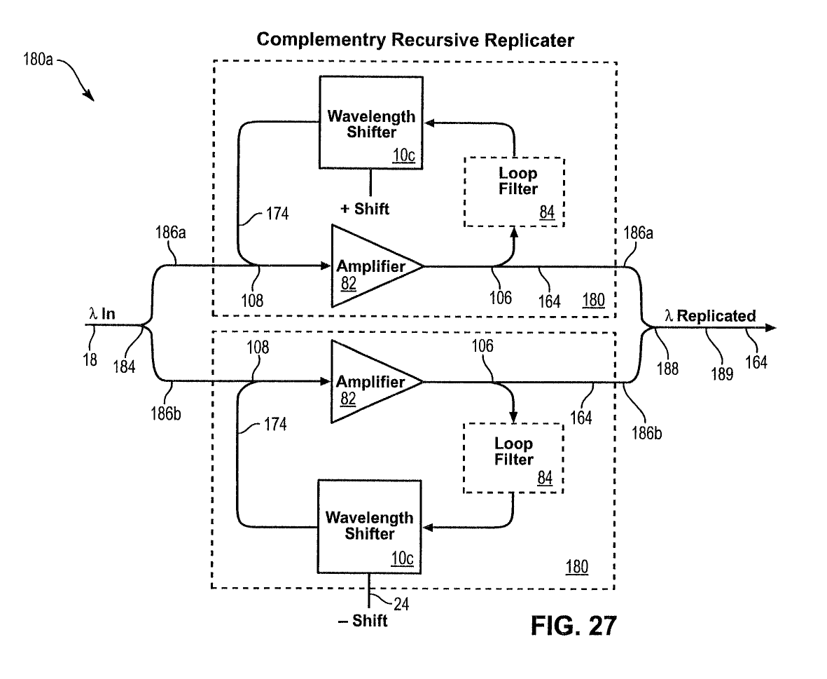

Referring to FIG. 27, a complementary recursive replicater 180a addresses the problem of phase canceling aphotonic signal. In the depicted embodiment, the complementary recursive replicater 180a may include two recursive wavelength-shifting replicaters 180, which are complementary. The replicaters are complementary in that one replicater may provide positive wavelength shifts, while the other replicater may provide negative wavelength shifts. The complementary replicaters may recursively shift the photonic signal 18 in opposite directions along the replicated spectrum 167.

A complementary path splitter 184 may split the photonic signal 18 to complementary paths 186a and 186b. The recursive wavelength-shifting replicaters 180 may receive the photonic signal 18 and provide two replicated photonic signals 164, which are complementary. The replicated photonic signals 164 may propagate along the complementary paths 186a and 186b. The complementary paths 186a and 186b may then be combined with a complementary path combiner 188 to provide a totally-replicated photonic signal 189.

The shift signals 24 provided to the recursive wavelength-shifting replicaters 180 may be complementary. One shift signal 24 may provide a positive shift while the other may provide a negative shift. The shift signals 24 may be substantially equal in magnitude.

The complementary recursive replicater 180a may be used to generate the replicated spectrum 167 that may span a vary broad spectral range. The replicated spectrum 167 may be a spectral comb. The replicated spectrum 167 may span both the 1330 nm and the 1550 nm ranges. The breadth of the span may be independent of the wavelength of the photonic signal 18. The complementary recursive replicater 180a may facilitate converting signals in the 1330 nm range to the 1550 nm range and vice versa.

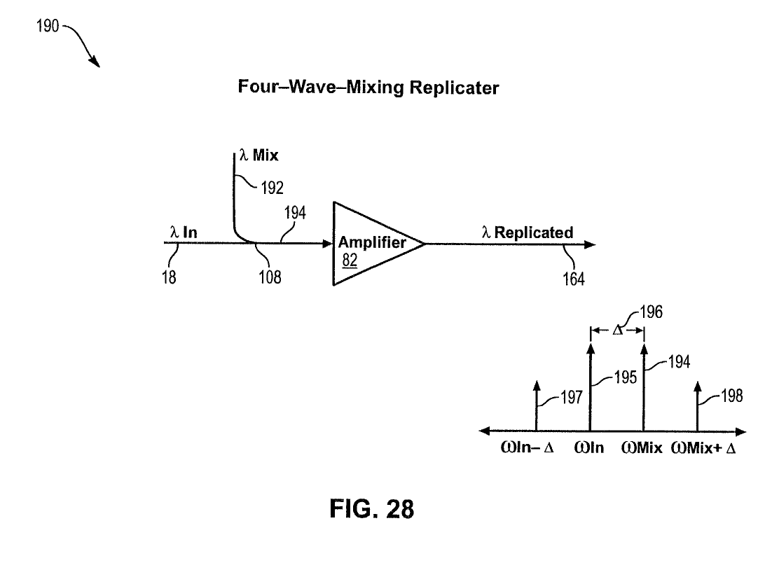

Referring to FIG. 28, a four-wave mixing replicater 190 may include a combiner 108 and an amplifier 82. A photonic signal 18 may be combined with a mixing signal 192 to provide a combined signal 194. The mixing signal 192 may include many wavelengths. The mixing signal 192 may be produced by a comb generator. The mixing signal 192 may have sufficient power to place the amplifier 82 into a non-linear region of operation. The amplifier 82 may receive the combined signal 184 and provide a replicated signal 164 that includes may copies of the photonic signal 18.

The mixing signal 192 may have a wavelength corresponding to frequency 194. The photonic signal 18 may have a wavelength corresponding to frequency 195. The difference in frequency 194 and 195 may be frequency difference 196. Four-wave mixing may place replicated copies at wavelengths corresponding to frequencies 197 and 198. Frequency 197 may be substantially equal to frequency 194 minus frequency difference 196. Frequency 198 may be substantially equal to frequency 195 plus frequency difference 196.

The mixing signal 192 may include many wavelengths. Each wavelength may produce two replicated copies of the photonic signal 18. The wavelengths of the mixing signal 192 may be selected to minimize spectral collisions between the replicated copies of the photonic signal 18 and the mixing signal 192.

One benefit of the four-wave mixing replicater 190 is the frequency inversion characteristic of four-wave mixing. Frequency inversion may reduce signal dispersion in a photonic medium. Signal dispersion is the result of shorter wavelengths having a different propagation speed in a photonic medium than longer wavelengths.

Frequency inversion effectively swaps the shorter and longer wavelengths associated with a signal and allows the slower wavelengths to catch up with the faster wavelengths. The resulting reduction in signal dispersion is an important factor in photonic systems, particularly long-haul systems. By placing frequency inverting transceivers at the beginning and midpoint of a transmission leg the dispersion of a signal may be greatly reduced.

The various embodiments for the spectrum replicater 162 highlighted in FIGS. 25-28 may be used to implement the replicated-spectrum transceiver 160. Particular embodiments may be advantageous in certain applications. For example, the wavelength-shifting replicater 170 may be embodied with few photonic components. The recursive wavelength-shifting replicater 180 may generate a broad single-sided spectral comb. In contrast, the complementary recursive replicater 180a may generate a broad double-sided spectral comb. The four-wave-mixing replicater 190 may be very simple to implement in that it comprises readily available components.

Based on the foregoing, it will be readily apparent that other mechanisms for spectrum replication may be constructed in accordance with the inventive principles set forth herein. It is intended, therefore, that the examples provided be viewed as exemplary of the principles of the present invention, and not as restrictive to a particular mechanism for implementing those principles.

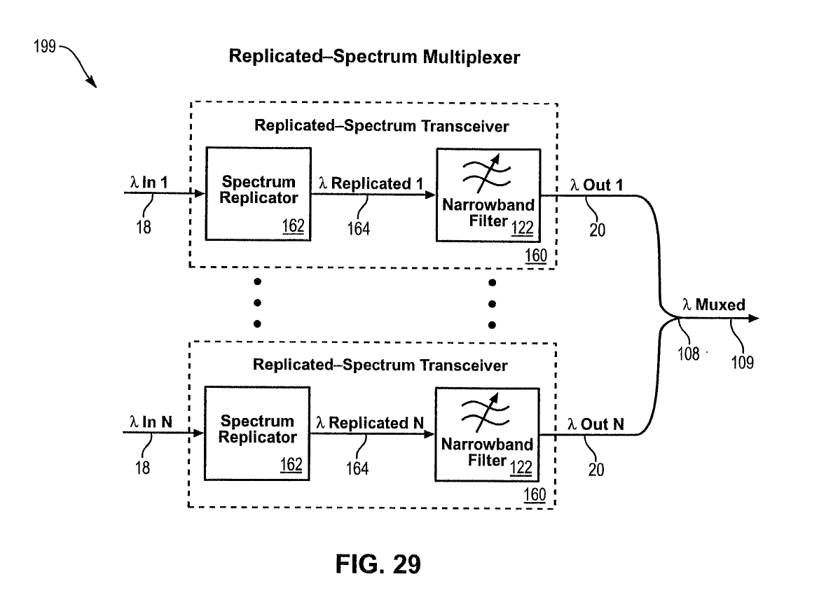

Referring to FIG. 29, a replicated-spectrum multiplexer 199 may be a broad-spectrum hyper-dense multiplexer. The replicated-spectrum multiplexer 199 may use the replicated-spectrum transceiver 160 (see FIG. 23) as a building block. An arbitrary number of replicated-spectrum transceivers 160 may be placed in parallel. Each replicated-spectrum transceiver 160 may receive aphotonic signal 18 and provide a channelized photonic signal 20. The channelized photonic signals 20 may be combined with a combiner 108 to provide a multiplexed photonic signal 109.

Each replicated-spectrum transceiver 160 may include a spectrum replicater 162. Each spectrum replicater 162 may receive the photonic signal 18 and provide a replicated photonic signal 164 containing many copies of the photonic signal 18. The replicated copies of the photonic signal 18 may span a very broad spectral range. The spacing of the replicated copies may be very dense. At least one copy of the photonic signal 18 may be passed through a narrowband filter 122 to provide the channelized photonic signal 20.

In some embodiments, the replicated-spectrum transceiver 160 may include a narrowband filter 122 that is tunable. Each narrowband filter 122 may be tuned to a unique wavelength. The tuning mechanism of the narrowband filter 122 may be dynamic. Dynamic tuning allows the replicated-spectrum transceiver 160 to operate as a switch element. In certain embodiments, the replicated-spectrum transceiver 160 may include a narrowband filter 122 that is fixed. Each narrowband filter 122 may be fixed at a unique wavelength.

One advantage of using the replicated-spectrum transceiver 160 to implement the replicated-spectrum multiplexer 199 is the simple modular design. The replication feature also simplifies setup and configuration. The replicated-spectrum multiplexer 199 may robustly adapt to changes in carrier wavelength. Due to the modular design, simplified setup, and broad spectral range, the replicated-spectrum multiplexer 199 may offer “plug-n-play” functionality. Photonic signals from the 1310 nm range maybe converted to the 1550 nm range and vice versa. Another advantage is the stability of the multiplexed signals. The stability is also determined by a low-cost passive device instead of active devices.

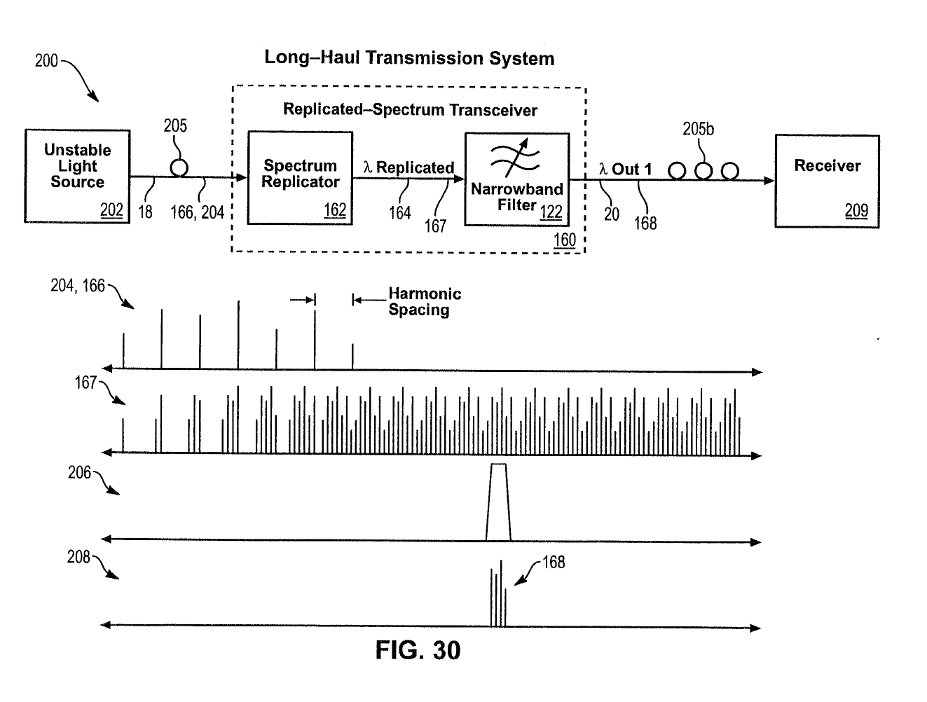

Referring to FIG. 30, a long-haul transmission system 200 may include an unstable light source 202, a transmission path 205, a replicated-spectrum transceiver 160, a long-haul transmission path 205b and a receiver 209. The unstable light source 202 may be inexpensive though generally unsuitable for a long-haul system 200. The replicated-transceiver 160 may convert the unstable light source 202 into a channelized photonic signal 20 suitable for use in long-haul photonic systems such as the long-haul transmission system 200.

Unstable light sources such as the unstable light source 202 are typically not associated with long-haul photonic systems. For example, the unstable light source 202 may be a semiconductor diode. The unstable light source 202 may generate an unstable spectrum 204 that is very broad with a comb-like harmonic structure composed of multiple spectral lines or harmonics. The broadness of the unstable spectrum 204 may increase the dispersion of a photonic signal 18 along a transmission path 205. Consequently, the transmission path 205 may be restricted to short-haul transmission. The ability to compensate for the shortcomings of the unstable spectrum 204 pertaining to long-haul transmission would be an advancement in the art.

At first glance it may appear desirable to bandpass filter the unstable signal 202 with a narrowband filter to generate a channelized photonic signal 20, which includes at least one harmonic of the unstable signal 202. While the overall power of the photonic signal 18 may be fairly consistent, the power of individual harmonics may vary greatly with time. Very few, if any, spectral lines of the unstable spectrum 204 may pass through a narrowband filter resulting in inconsistent or insufficient power. Even a slow variation of less than 1 Hz may result in unacceptable power variations.

Broadening the narrowband filter 122 to increase and stabilize the power of the channelized photonic signal 20 may reduce the number of signals that may be multiplexed. Selecting a spectral line that has the right power level and wavelength at any given time may add undue complexity to the control mechanisms of a long-haul system 200.

Another problem with the unstable signal 202 is that the harmonic wavelengths of the unstable signal 202 may drift considerably with temperature. The drift may be as high as 80 gHz per degree Celsius. The unstable light source 202 may not be accessible making temperature stabilization or compensation impossible.

The capacity of transmission and multiplexing systems may be increased through two seemingly conflicting objectives. The first is to increase the stability of a signal so that it may remain within a smaller spectral slice. The second is to increase the bandwidth that may be spectrally divided or sliced. While the unstable signal 202 may be broad from a transmission point of view, from a multiplexing point it may not be broad enough. A broader selection of wavelengths may be desirable. A broader selection of wavelengths facilitates the multiplexing of more photonic signals.

Continuing to refer to FIG. 30, the replicated-spectrum transceiver 160 may compensate for the unique characteristics of the unstable light source 202 and its associated unstable spectrum 204. The replicated-spectrum transceiver 160 may convert the unstable light source 202 into a channelized photonic signal 20 that is highly suited for dense multiplexing and long-haul transmission along a long-haul transmission path 205b.

The replicated-spectrum transceiver 160 may include a spectrum replicater 162. The spectrum replicater 162 may produce a replicated signal 164 that interleaves the replicated copies of the unstable light source 202 such that the replicated spectrum 167 contains a sufficient density of spectral lines over a very broad spectral region. Narrowband filtering the replicated spectrum 164 with a narrowband filter 122 having a spectral envelope 206 may produce a channelized photonic signal 20. The channelized photonic signal 20 may have a narrowband spectrum 208 suitable for long-haul transmission. The narrowband spectrum 208 may be received by a receiver 209.

The spectrum replicater 162 may comprise, for example, a recursive wavelength-shifting replicater 180. The recursive wavelength shift may be selected to be between .5 and 1.5 times the harmonic spacing of the unstable spectrum 204. For instance, an unstable spectrum 204 with a harmonic spacing of 117 gHz may be recursively wavelength shifted by 157 gHz.

In some embodiments, it may be desirable to wavelength shift by slightly more or slightly less than the harmonic spacing of the unstable spectrum 204. A wavelength shift equal to the harmonic spacing may be avoided, since placing harmonics directly upon each other may result in phase beating or other undesirable characteristics. The amount of wavelength shifting may account for variations in the harmonic spacing of the unstable spectrum 204. The amount of wavelength shifting may be calculated and selected to reduce the likelihood of harmonic collisions.

Long-haul transmission signals are preferably stable and spectrally narrow. The replicated-spectrum transceiver 160 may be used to convert an unstable light source 202 to a channelized photonic signal 20 that is stable and spectrally narrow. Other methods and mechanisms may also produce photonic signals suitable for long-haul transmission.

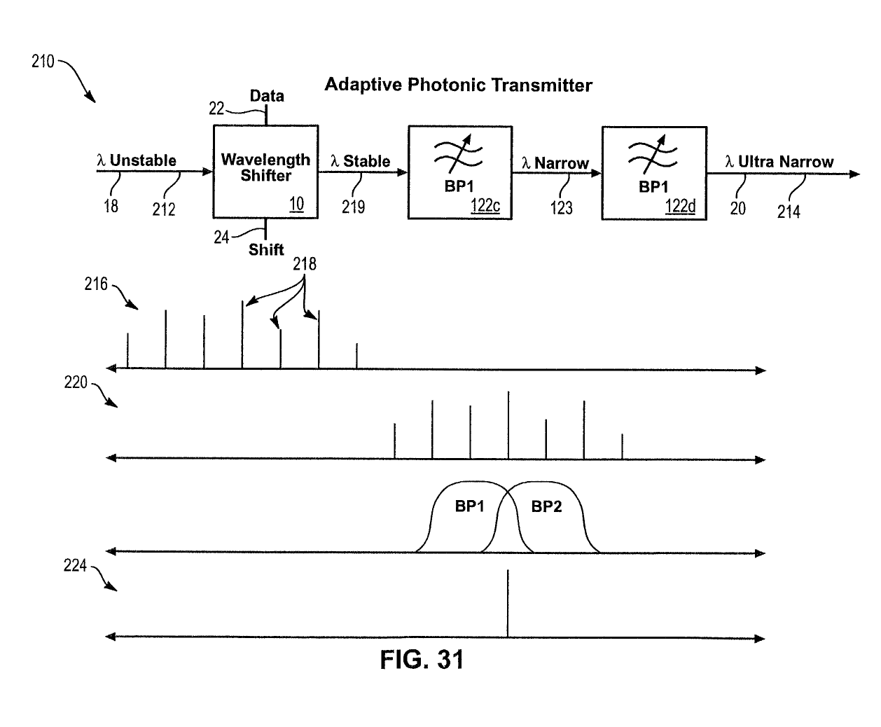

Referring to FIG. 31, an adaptive photonic transmitter 210 may include a wavelength shifter 10 and narrowband filters 122c and 122d. The adaptive photonic transmitter 210 may stabilize and spectrally narrow an unstable photonic signal 212 and provide an ultra-narrow photonic signal 214. The adaptive photonic transmitter 210 may also encode data into the ultra-narrow photonic signal 214.

The unstable photonic signal 212 may be unstable and spectrally broad. The unstable photonic signal 212 may originate from an inexpensive source such as a semiconductor diode. The unstable photonic signal 212 may be unsuitable for long haul transmission or high-density multiplexing. The unstable photonic signal 212 may have a broad unstable spectrum 216 composed of multiple spectral lines 218.

The wavelength shifter 10 may stabilize and shift the wavelength of the unstable photonic signal 212 to provide a stabilized photonic signal 219. In certain embodiments, the stabilized photonic signal 219 may have a broad stable spectrum 220 centered about a desired wavelength. In other embodiments, the stabilized photonic signal 219 may have a spectral line 218 whose wavelength is shifted to be close to the desired wavelength.

Deviations from the desired wavelength may cause the wavelength shifter 10 to adjust the amount of wavelength shifting. The wavelength shifter 10 may lock the stabilized photonic signal 219 at the desired wavelength. The wavelength shifter 10 may also superimpose a wavelength pattern provided by the shift signal 24 onto the stabilized photonic signal 219. The superimposed wavelength pattern may be centered about the desired wavelength.

A first narrowband filter 122c may bandpass filter the stabilized photonic signal 219 and provide a narrowband signal 123. The narrowband signal 123 may have a spectrum that is more narrow than the broad stable spectrum 220. However, the spectrum of the narrowband signal 123 may be too broad for a particular application.

A second narrowband filter 122d may further narrow the narrowband signal 123 by filtering out a portion of the spectrum of the narrowband signal 123. The first and second narrowband filters 122c and 122d may produce an ultra-narrow photonic signal 214. The ultra-narrow photonic signal 214 may have an ultra-narrowband spectrum 224 that is narrower than the passband of either filter.

The first and second narrowband filters 122c and 122d may have passband wavelengths that are offset such that only a portion of their passbands overlap. The overlapping portion of their passbands may correspond to the ultra-narrowband spectrum 224. The ultra-narrow photonic signal 214 may be suitable for long-haul transmission and high-density multiplexing.

In certain embodiments, the first and second narrowband filters 122c and 122d may be matched filters. They may share the same reflecting filter such as the reflecting filter 128 shown in some of the Figures. They may also be physically separate filters made from the same material or manufacturing lot.

Some embodiments may use temperature control mechanisms to stabilize and tune the passband wavelengths of the first and second narrowband filters 122c and 122d. For example, a pair of Peltier devices may be used to electronically control the temperature and passband wavelengths. The biasing voltages of the pair of Peltier devices may be offset such that the passband wavelengths may be predictably offset.

In certain embodiments, the spectral content of various signals, for example the narrowband signal 123, may be monitored to control operation of the adaptive photonic transmitter 210. A control unit may spectrally analyze a signal and provide feedback to tune the output of the adaptive photonic transmitter 210 to a desired passband wavelength.

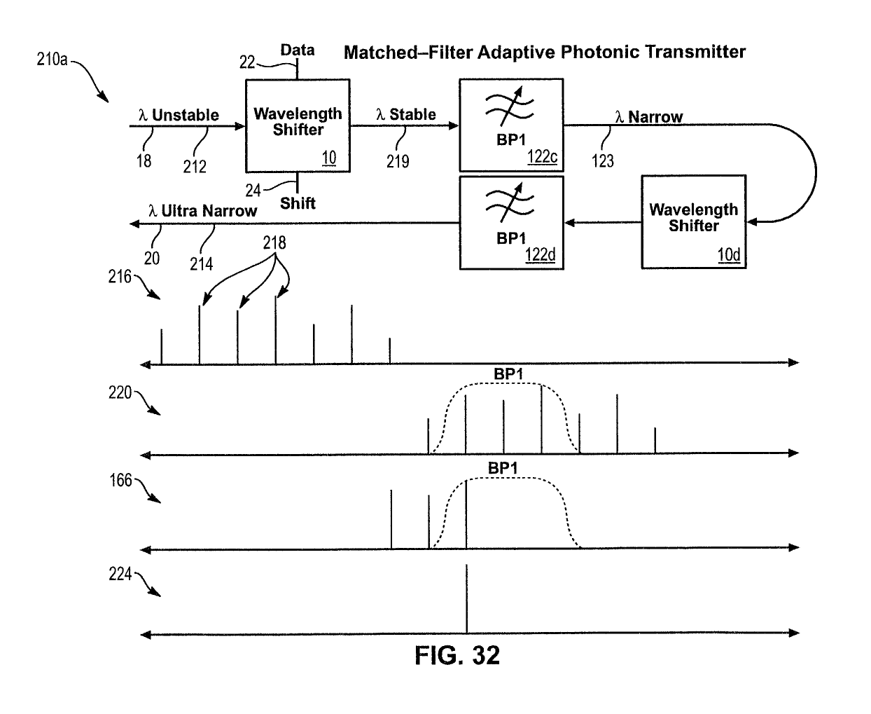

Referring to FIG. 32, a matched-filter adaptive photonic transmitter 210a may include two wavelength shifters 10c and 10d, and two narrowband filters 122c and 122d. The matched-filter adaptive photonic transmitter 210a may better stabilize and spectrally narrow an unstable photonic signal 212 than the adaptive photonic transmitter 210. The matched-filter adaptive photonic transmitter 210a may encode data into the ultra-narrow photonic signal 214.

The unstable photonic signal 212 may originate from an unstable, spectrally broad photonic source such as an unstable light source 202. The unstable photonic signal 212 may be unsuitable for long haul transmission or high-density multiplexing. The unstable photonic signal 212 may have a broad unstable spectrum 216 composed of multiple spectral lines 218.

A first wavelength shifter 10c may stabilize and shift the wavelength of the unstable photonic signal 212 to provide a stabilized photonic signal 219. A first narrowband filter 122c may bandpass filter the stabilized photonic signal 219 and provide a narrowband signal 123. The narrowband signal 123 may have a narrowband spectrum 166 that is more narrow than the broad stable spectrum 220. However, the narrowband signal 123 may be too broad for a particular application.

A second wavelength shifter 10d may wavelength shift the narrowband signal 123 by a portion of the passband width. Wavelength shifting the narrowband signal 123 facilitates using a second narrowband filter 122d with a matching passband. The second narrowband filter 122d may further narrow the narrowband signal 123 by filtering out that portion of the narrowband spectrum 166 that is shifted outside the passband by the second wavelength shifter 10d.

Adding the second wavelength shifter 10d to the matched-filter adaptive photonic transmitter 210a facilitates precise control of the ultra-narrow photonic signal 214. Although the first and second narrowband filters 122c and 122d may have passbands that are fairly broad and substantially identical, the ultra-narrow photonic signal 214 may have an ultra-narrowband spectrum 224 that is much narrower than the passband of either filter. The ultra-narrow photonic signal 214 may be suitable for long-haul transmission and high-density multiplexing.

The first and second narrowband filters 122c and 122d are preferably matched filters. They may share the same reflecting filter such as the reflecting filter 128 shown in some of the Figures. In some embodiments however, they may be physically separate filters made from the same material or manufacturing lot.

Some embodiments may use temperature control mechanisms to stabilize and tune the passband wavelengths of the first and second narrowband filters 122c and 122d to be nearly identical. For example, a pair of Peltier devices may be used to electronically control the temperature and passband wavelengths. The biasing voltages of the pair of Peltier devices may be adjusted such that the passband wavelengths may substantially the same.

In certain embodiments the spectral content of various signals, for example the narrowband signal 123, may be monitored to control operation of the matched-filter adaptive photonic transmitter 210a. A control unit may spectrally analyze a signal and provide feedback to tune the output of the matched-filter adaptive photonic transmitter 210a to a desired passband width and wavelength.

From the above discussion, it will be appreciated that the present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for coherent wavelength-shift multiplexing, the apparatus comprising:
a photonic input path configured to carry a photonic input signal having a base wavelength definable as a function of time;
a photonic output path configured to carry a multiplexed photonic signal comprising a reference channel and a data channel, the reference channel and the data channel each having a wavelength pattern uniquely corresponding thereto;
a splitter configured to split the photonic input signal into first and second daughter signals;
a data signal;
a modulation synthesizer configured to provide a first modulation waveform configured to shift the base wavelength to substantially match the wavelength pattern of the reference channel, provide a second modulation waveform configured to shift the base wavelength to substantially match the wavelength pattern of the data channel, and pre-modulate the second modulation waveform to encode the data signal into the data channel signal;
first and second modulation devices configured to modulate the first and second daughter signals in accordance with the first and second modulation waveforms, respectively, to provide a photonic reference signal corresponding to the reference channel and a photonic data signal corresponding to the data channel; and
a combiner configured to combine the photonic reference signal and the photonic data signal to provide the multiplexed photonic signal.

2. The apparatus of claim 1, further comprising:
a wavelength error detector configured to detect wavelength pattern errors in the multiplexed photonic signal and provide a wavelength error signal; and
the modulation synthesizer further configured to adjust the modulation waveforms in proportion to the wavelength error signal, thereby correcting the wavelength pattern errors.

3. The apparatus of claim 2, wherein the wavelength error detector is configured to detect wavelength pattern errors in the reference channel.

4. The apparatus of claim 1, wherein the modulation synthesizer is configured to encode the data signal by a step selected from the group consisting of phase-shift keying, amplitude-shift keying, and pre-modulating with orthogonal codes.

5. The apparatus of claim 1, further comprising:
a shift input line configured to carry a shift signal; and
the modulation synthesizer further configured to provide a modulation waveform configured to shift the base wavelength in proportion to the shift signal.

6. The apparatus of claim 5, wherein the shift signal is characterized by a function selected from the group consisting of a spreading function, a gathering function, a difference of two spreading functions, and a range of allowable wavelength shifts.

7. The apparatus of claim 1, wherein the modulation device is selected from the group consisting of a phase modulator and a quadrature amplitude modulator.

8. The apparatus of claim 7, wherein the quadrature amplitude modulator comprises an upper branch and a lower branch, each having a transfer function corresponding thereto, the modulation waveform being a quadrature waveform comprised of upper and lower waveform components corresponding to the upper and the lower branch, respectively, the upper and lower waveform components being substantially 90 degrees out of phase.

9. The apparatus of claim 8, wherein the upper and lower waveform components each have a value that is substantially that of a sinusoid divided by the respective transfer function corresponding to the respective upper and lower branch.

10. The apparatus of claim 8, wherein the upper and lower waveform components are selected from the group consisting of a substantially sawtooth shape and a substantially triangular shape.

11. The apparatus of claim 1, wherein the modulation waveform is selected from the group consisting of a substantially sawtooth shape and a substantially triangular shape.

12. A method for coherent wavelength-shift multiplexing comprising:
providing a photonic input signal having a base wavelength definable as a function of time;
splitting the photonic input signal into first and second daughter signals;
providing a data signal;
providing a first modulation waveform configured to shift the base wavelength to substantially match a wavelength pattern of a reference channel;
providing a second modulation waveform configured to shift the base wavelength to substantially match a wavelength pattern of a data channel;
encoding the data signal by pre-modulating the second modulation waveform;
modulating the first and second daughter signals in accordance with the first and second modulation waveforms, respectively, to provide a photonic reference signal corresponding to the reference channel and a photonic data signal corresponding to the data channel; and
combining the photonic reference signal and the photonic data signal to provide a multiplexed photonic signal.

13. The method of claim 12, further comprising:
detecting wavelength pattern errors in the multiplexed photonic signal; and
adjusting the first and second modulation waveforms to correct the wavelength pattern errors.

14. The method claim 13, wherein detecting comprises detecting wavelength pattern errors in the reference channel.

15. The method of claim 12, wherein the data signal is encoded by a technique selected from the group consisting of phase-shift keying, amplitude-shift keying, and pre-modulating with orthogonal codes.

16. The method of claim 12, further comprising:
providing a shift signal; and
providing a modulation waveform configured to shift the base wavelength in proportion to the shift signal.

17. The method of claim 16, wherein the shift signal is characterized by a function selected from the group consisting of a spreading function, a gathering function, and a difference of two spreading functions.

18. The method of claim 12, wherein modulating is selected from the group consisting of phase modulation, quadrature amplitude modulation, and modulating by providing the second modulation waveform as a quadrature waveform comprising first and second waveform components that are substantially 90 degrees out of phase.

19. The method of claim 18, wherein at least one of the first and second waveform components each have a value selected from the group consisting of a sinusoid divided by a transfer function corresponding to a modulation device, a substantially sawtooth shape, and a substantially triangular shape.

20. An apparatus for coherent wavelength shift demultiplexing comprising:
a photonic input path configured to carry a multiplexed photonic signal comprising a reference channel and a data channel, the reference channel and the data channel each having a wavelength pattern uniquely corresponding thereto;
a splitter configured to split the multiplexed photonic signal into a photonic input signal and a photonic reference signal;
a modulation synthesizer configured to provide a modulation waveform effective to change the wavelength pattern of the data channel to the wavelength pattern of the reference channel;
a modulation device configured to modulate the photonic input signal with the modulation waveform to provide a photonic output signal; and
a coherence detector configured to compare the photonic output signal with the photonic reference signal, thereby extracting a data signal.
